(19) United States
(12) Patent Application Publication
(10) Pub. No.: US 2024/0027591 A1
(43) Pub. Date: Jan. 25, 2024

(54) LIGHT DETECTION SYSTEM AND METHODS THEREOF

(71) Applicant: OSRAM GmbH, München (DE)

(72) Inventors: Gerhard Maierbacher, München (DE); Bernhard Siessegger, Unterschleissheim (DE)

(21) Appl. No.: 18/255,953

(22) PCT Filed: Dec. 9, 2021
(86) PCT No.: PCT/EP2021/085012

§ 371 Date: Jun. 5, 2023

(30) Foreign Application Priority Data
Dec. 10, 2020 (DE) 10 2020 132 971.7

(51) Int. Cl. G01S 7/487; G01S 17/10

(52) U.S. Cl. CPC G01S 7/4873; G01S 17/10

(57) ABSTRACT

In an embodiment a light detection system includes a detector configured to provide a received light signal and a processing circuit configured to identify a number of peaks in the received light signal and to estimate a signal-to-noise ratio associated with the received light signal based on the number of identified peaks.

### CROSS-REFERENCE TO RELATED APPLICATIONS

This patent application is a national phase filing under section 371 of PCT/EP2021/085012, filed Dec. 9, 2021, which claims the priority of German patent application 10 2020 132 971.7, filed Dec. 10, 2020, each of which is incorporated herein by reference in its entirety.

### TECHNICAL FIELD

Various aspects are related to a light detection system and methods thereof (e.g., a method of detecting light), and various aspects are related to a LIDAR (“Light Detection and Ranging”) system including a light detection system.

### BACKGROUND

Light detection and ranging is a sensing technique that is used, for example, in the field of autonomous driving for providing detailed information about the surrounding of an automated or partially automated vehicle. Light is used to scan a scene and determine the properties (e.g., the location, the speed, the direction of motion, and the like) of the objects present therein. A LIDAR system typically uses the time-of-flight (ToF) of the emitted light to measure the distance to an object. A LIDAR system may include one of a high-speed analog-to-digital converter (ADC) or a time-to-digital converter (TDC) for processing the light received from the scene. An ADC-based solution may provide amplitude information, which may be useful for object detection and object fusion (the respective algorithms may make use of amplitude information). In addition, in an ADC-based solution, the signal-to-noise ratio may be derived, which may provide a measure of how reliable the measurement was. However, a high-speed ADC may be expensive in terms of power consumption, heat, cost, complexity, etc. Furthermore, the continuous sampling at high sampling rates generates large amounts of data which need to be communicated and processed. In addition, not all detectors provide an amplitude information (e.g., single photon avalanche diode (SPAD) detectors do not provide such information). A LIDAR architecture adopting a TDC approach may have various advantages with respect to an ADC approach: (1) a simple system setup that reduces the number of expensive components while being suitable for high-speed implementations; (2) compared to waveform sampling solutions no high-speed ADC is needed, which may be beneficial with respect to power consumption and cost; and (3) in view of the event-based nature of a TDC detection scheme the amount of generated data may be relatively small, thus reducing the amount of data to process (illustratively, less CPU load is generated) and reducing the needed CPU-power, which leads to a decrease in the power consumption and cost of the system. However, a limitation of a usual TDC-based system is that it does not provide signal-to-noise ratio (SNR) information and/or amplitude information.

### SUMMARY

Various aspects may be related to a strategy for determining (e.g., estimating or calculating) the signal-to-noise ratio and/or amplitude information in light detection based on a time-to-digital conversion approach. Various aspects may be based on providing a light signal configured to enable estimating the signal-to-noise ratio (and the amplitude) in TDC-based light detection. Such light signal may be referred to herein as an adapted light signal or pilot light signal. In some aspects, an adapted light signal may include a plurality of light pulses, e.g. an adapted light signal may be a multi-pulse signal. Various aspects may be related to a light detection system configured according to a time-to-digital conversion approach and adapted to determine signal-to-noise ratio and/or amplitude information associated with a received light signal. In some aspects, a LIDAR system may include the light detection system described herein, and the SNR information and/or amplitude information provided by the light detection system may be used for subsequent processing steps, such as object detection, object tracking, and sensor fusion stages, as examples.

In the context of the present disclosure, reference may be made to a LIDAR system. It is however understood that a LIDAR system is an example of a possible application of the strategy described herein for determining the signal-to-noise ratio associated with a light signal. The method and the light detection system described herein may also be for use in other types of application or systems in which determining the signal-to-noise ratio of a light signal may be advantageous, for example in an optical transmission system (e.g., wireless or including optical fibers), e.g. in a system in which data and information may be transmitted by means of light.

In various aspects, a method of detecting light (e.g., a method of estimating a signal-to-noise ratio associated with a light signal) may include: providing a received light signal; identifying a number of peaks in the received light signal, and estimating a signal-to-noise ratio associated with the received light signal based on the number of identified peaks.

In various aspects, a light detection system may include: a detector configured to provide a received light signal; and a processing circuit configured to: identify a number of peaks in the received light signal, and estimate a signal-to-noise ratio associated with the received light signal based on the number of identified peaks.

In various aspects a LIDAR system may include: a light emission system configured to emit a light signal, the light signal including a plurality of peaks; and a light detection system including: a detector configured to receive the light signal and provide a received light signal, and a processing circuit configured to identify a number of peaks in the received light signal, and to determine a signal-to-noise ratio associated with the received light signal based on the number of identified peaks. The LIDAR system may be part, for example, of a vehicle, of a smart farming, or of an indoor monitoring system.

By way of illustration, a LIDAR system described herein may be understood as a TDC-based LIDAR architecture that uses several pulses (a so-called multi-pulse) for ranging. The multi-pulse signal may be used to derive SNR and/or amplitude information with a TDC-based scheme. A TDC-based solution may ensure low system-complexity (in particular when compared to an ADC-based solution). A TDC-based solution may be suitable for high speed implementations, it does not require continuous high-speed sampling (but it is rather an event-based detection), and may ensure a low data rate. Furthermore, a TDC-based solution may work even with “binary” detector signals (e.g. with SPAD detector outputs), and, depending on the architecture, may be suitable for multi-hit detection. The approach described herein may obviate the disadvantages of a usual TDC approach of not providing SNR information and/or amplitude information.

The term “peak” may be used herein to describe a portion of a signal (e.g., of a light signal, a current signal, a voltage signal, etc.) as commonly understood in signal analysis. As an illustrative explanation, a peak may be understood as a portion of the signal having a full width at half maximum less than a predefined value (e.g., less than 10 ns, or less than 3 ns, or less than 1 ns, or less than 0.5 ns, as examples) and an amplitude (also referred to as height) greater than a predefined value (e.g., greater than a noise level). A signal may have a signal component, and a noise component superimposed to the signal component. A peak may be understood, in some aspects, as a portion of the signal component being greater than a noise level (also referred to herein as noise floor, e.g. an average value of the noise component) and at which a signal level reaches a (local) maximum value.

In some aspects, a peak of a signal may be associated with a pulse (e.g., a light pulse, a current pulse, a voltage pulse, etc.). Illustratively, a signal may include one or more pulses (e.g., one or more light pulses, one or more current pulses, one or more voltage pulse, etc.), each associated with a respective peak of one or more peaks. The peak may be understood as the point of the pulse at which a signal level of the pulse (e.g., a power level, a current level, a voltage level, or an amplitude level, as described below) has the greatest absolute value. In the following, some properties may be described in relation to a peak, and some properties may be described in relation to the pulse associated with the peak. It is understood that the properties described in relation to a pulse may apply also to the corresponding peak associated therewith, e.g. in case a pulse is described as having a certain property it may be understood that the pulse may have that property at the associated peak (e.g., that signal level at the peak, as an example). It is also understood that the properties described in relation to a peak may apply also to the corresponding pulse associated therewith, e.g. in case a peak is described as having a certain property it may be understood that the associated pulse may have that property at the peak (e.g., that signal level at the peak, as an example).

The expression “signal level” may be used herein to describe a parameter associated with a signal (e.g., with a light signal, a current signal, a voltage signal, etc.) or with a portion of a signal (e.g., with a peak). A “signal level” as used herein may include at least one of a power level, a current level, a voltage level, or an amplitude level (also referred to herein as amplitude).

The term “amplitude” may be used herein to describe the height of a peak, e.g. the height of a pulse. The term “amplitude” may describe the signal level of the signal at the peak with respect to a reference value for the signal level. The term “amplitude” may be used herein also in relation to a signal that is not a symmetric periodic wave, e.g. also in relation to an asymmetric wave (for example in relation to a signal including periodic pulses in one direction). In this regard, the term “amplitude” may be understood to describe the amplitude of the signal (e.g., of the peak) as measured from the reference value of the signal level.

The term “processor” as used herein may be understood as any kind of technological entity that allows handling of data. The data may be handled according to one or more specific functions executed by the processor. Further, a processor as used herein may be understood as any kind of circuit, e.g., any kind of analog or digital circuit. A processor may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor or logic circuit. It is understood that any two (or more) of the processors or logic circuits detailed herein may be realized as a single entity with equivalent functionality or the like, and conversely that any single processor or logic circuit detailed herein may be realized as two (or more) separate entities with equivalent functionality or the like.

In the following, various graphs associated with a light signal may be illustrated and described, in which a power associated with the light signal is plotted versus the time. It is understood that the representation in terms of power is only an example, and the description provided below may apply also to the case in which the light signal is plotted in terms of a different parameter, e.g. a current, a voltage, and the like. It is also understood that the values illustrated in the graphs and described in relation to the graphs are exemplary values which may be adapted in accordance with desired properties of the light signal (e.g., a power may be increased or decreased, for example).

In the following, some values (e.g., associated with a power or a power level of a signal) may be provided according to a linear scale (e.g., in watts W), or according to a logarithmic scale (e.g., in decibel dB or decibel watts dBW). In some aspects, the values expressed according to the linear scale may be converted to corresponding values according to the logarithmic scale, assuming a reference value to which the values are compared to (e.g., 1 W). As an example, in case of a power PL expressed according to a linear scale, a corresponding power PD expressed in a logarithmic scale may be derived as PD=10*log 10(PL/PR), where PR may be a reference power (e.g., 1 W). It is also understood that values expressed in dBW may be combined (e.g., added or subtracted) with values expressed in dB, as commonly known in the art.

In the following, a light signal may be described, for example, as an adapted light signal or as a received light signal (also referred to herein as detected light signal). An adapted light signal may be understood, in some aspects, as the light signal that should ideally be received (e.g., at a light detection system), e.g. as the light signal that would be received in absence of noise. A received light signal may be understood, in some aspects, as the light signal that is actually received (e.g., at the light detection system), illustratively including a noise component (a noise signal) superimposed to an adapted light signal. In some aspects, an adapted light signal may be a light signal emitted by a light emission system (e.g., of a LIDAR system), and a received light signal may be the emitted light signal as received by a light detection system (e.g., of the LIDAR system), including noise. In some aspects, a received light signal may be associated with an adapted light signal, e.g. the received light signal may include the adapted light signal and a noise signal superimposed thereto, e.g. the received light signal may be a noisy version of the (emitted) adapted light signal associated therewith. An adapted light signal may be a light signal provided for a certain operation (e.g., for ranging in a LIDAR system, for data communication in an optical communication system, etc.), which is also configured to enable signal-to-noise ratio (and amplitude) estimation in a TDC-based approach.

### BRIEF DESCRIPTION OF THE DRAWINGS

In the drawings, like reference characters generally refer to the same parts throughout the different views. The drawings are not necessarily to scale, emphasis instead generally being placed upon illustrating the principles disclosed herein. In the following description, various aspects disclosed herein are described with reference to the following drawings, in which:

FIG. 1A shows a schematic flow diagram of a method of detecting light according to various aspects;

FIG. 1B shows schematically a graph associated with an adapted light signal according to various aspects;

FIG. 1C and FIG. 1D each shows schematically a graph associated with a received light signal according to various aspects;

FIG. 2A to FIG. 2G each shows schematically a graph associated with an adapted light signal according to various aspects;

FIG. 3A shows schematically a graph associated with an adapted light signal according to various aspects;

FIG. 3B and FIG. 3C each shows schematically a graph associated with a received light signal according to various aspects;

FIG. 4 shows schematically a light detection system according to various aspects;

FIG. 5 shows schematically a detector according to various aspects;

FIG. 6 shows schematically a processing circuit according to various aspects;

FIG. 7A shows schematically a threshold determination circuit according to various aspects;

FIG. 7B shows schematically a noise floor measurement circuit according to various aspects;

FIG. 8A shows schematically a peak detection circuit according to various aspects;

FIG. 8B and FIG. 8C each shows schematically a trigger event register according to various aspects;

FIG. 9A and FIG. 9B each shows schematically a light detection system according to various aspects; and

FIG. 10 shows schematically a LIDAR system, according to various aspects.

### DETAILED DESCRIPTION OF ILLUSTRATIVE EMBODIMENTS

The following detailed description refers to the accompanying drawings that show, by way of illustration, specific details and aspects disclosed herein may be practiced. These aspects are described in sufficient detail to enable those skilled in the art to practice the disclosed implementations. Other aspects may be utilized and structural, logical, and electrical changes may be made without departing from the scope of the disclosed implementations. The various aspects are not necessarily mutually exclusive, as some aspects may be combined with one or more other aspects to form new aspects. Various aspects are described in connection with methods and various aspects are described in connection with devices (e.g., a light detection system, a processing circuit, a detector, etc.). However, it is understood that aspects described in connection with methods may similarly apply to the devices, and vice versa.

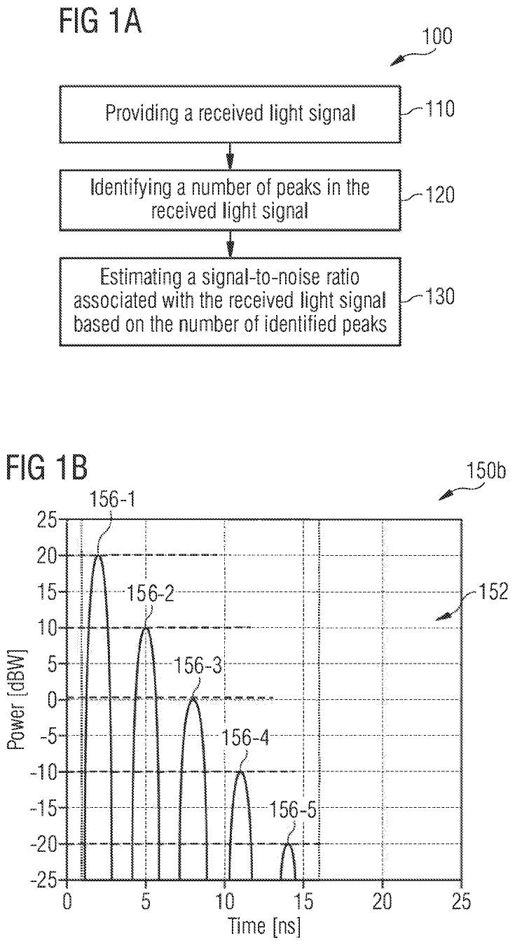

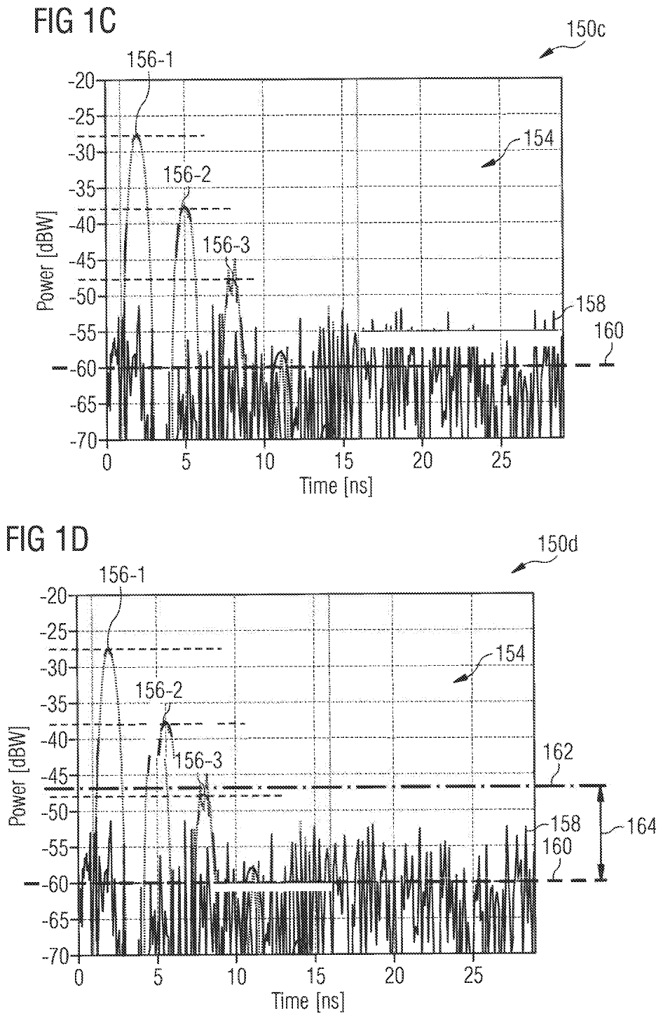

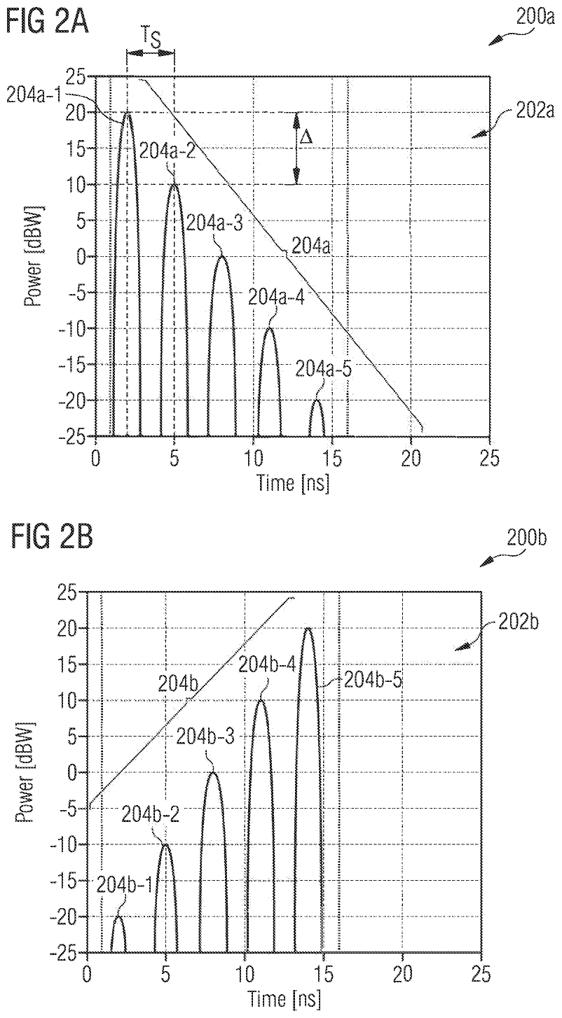

FIG. 1A shows a schematic flow diagram of a method 100 of detecting light according to various aspects. The method 100 may be understood, in some aspects, as a method of estimating a signal-to-noise ratio associated with a received light signal. In some aspects, the method 100 may be a method of detecting light implemented in a LIDAR system, e.g. in a LIDAR system configured according to a time-to-digital conversion approach. Illustratively, the method 100 may be a method of detecting light emitted by a LIDAR system.

The method 100 may include, in no, providing a received light signal. Illustratively, the method 100 may include receiving a light signal and providing a representation of the received light signal. In some aspects, providing a received light signal may be understood as detecting a light signal, and providing a representation of the detected light signal. As an example, the method 100 may include providing an analog signal (e.g., a current or a voltage) associated with the received light signal, e.g. an analog signal representing the received light signal. In some aspects, a received light signal may be provided as a representation that may be processed by a processing circuit, as described in further detail below. In some aspects, the method 100 may include performing a time-to-digital conversion of the received light signal (to provide a digitized representation of the received light signal, also referred to herein as digital representation of the received light signal).

The method 100 may include, in 120, identifying a number of peaks in the received light signal. Identifying a number of peaks may include determining (e.g., counting) how many peaks can be detected (in some aspects, distinguished) in the received light signal. Illustratively, the method 100 may include counting the number of distinguishable peaks in the received light signal, e.g. counting the number of peaks that fulfill one or more predefined criteria, as described in further detail below. The received light signal may include noise and the method 100 may include determining how many peaks may be distinguished from the noise in the received light signal. In some aspects, identifying a number of peaks in the received light signal may be understood as identifying a number of light pulses in the received light signal.

The method 100 may include, in 130, estimating a signal-to-noise ratio associated with the received light signal based on the number of identified peaks (illustratively, by using the number of identified peaks, or in accordance with the number of identified peaks). Estimating the signal-to-noise ratio may be understood, in some aspects, as calculating the signal-to-noise ratio, e.g. as calculating an approximate value for the signal-to-noise ratio.

The method 100 may include estimating the signal-to-noise ratio by using known properties of an adapted light signal associated with the received light signal, illustratively by comparing the actually received light signal with the known adapted light signal from which the received light signal has been provided. The method 100 may include estimating the signal-to-noise ratio by comparing the peaks identified in the received light signal with the peaks of the known adapted light signal associated with the received light signal. Illustratively, a received light signal may be compared with the known properties and configuration that the received light signal would have in absence of noise.

In some aspects, estimating the signal-to-noise ratio may include estimating the signal-to-noise ratio associated with the received light signal based on the number of identified light pulses, e.g. by comparing the light pulses identified in the received light signal with the light pulses of the known adapted light signal associated therewith.

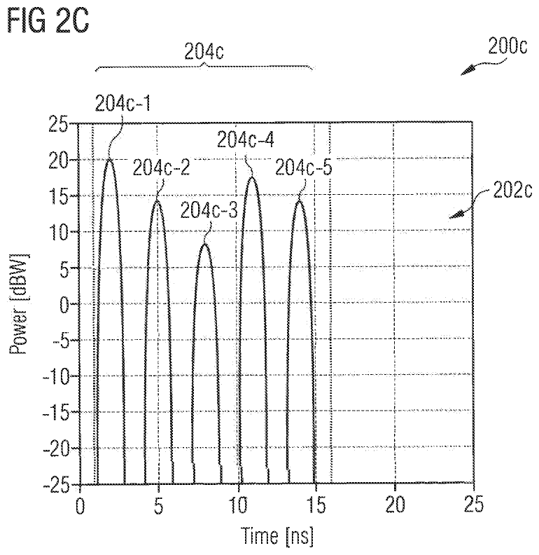

The various aspects of the method 100 may be further explained with reference to the FIG. 1B, FIG. 1C, and FIG. 1D, each showing a respective graph 150b, 150c, 150d associated with an adapted light signal 152 (FIG. 1B) or a received light signal 154 (FIG. 1C and FIG. 1D). The adapted light signal 152 may be associated with the received light signal 154, i.e. in absence of noise the received light signal 154 would correspond to the adapted light signal 152. It is understood that the adapted light signal 152 described in relation to FIG. 1B, and the received light signal 154 described in relation to FIG. 1C and FIG. 1D are only an example, and light signals having a different shape or configuration may be provided, as described in further detail below, for example in relation to FIG. 2A to FIG. 2G. In the graphs 150b, 150c, 150d, the horizontal axis (the x-axis) may be associated with the time (in ns), and the vertical axis (the y-axis) may be associated with the power (in a logarithmic scale, in dBW).

In various aspects, an adapted light signal may include a plurality of peaks, e.g. a plurality of light pulses (also referred to herein as sub-pulses) each associated with a respective peak. In the exemplary configuration in FIG. 1B, the adapted light signal 152 may include a first light pulse 156-1 (associated with a first peak), a second light pulse 156-2 (associated with a second peak), a third light pulse 156-3 (associated with a third peak), a fourth light pulse 156-4 (associated with a fourth peak), and a fifth light pulse 156-5 (associated with a fifth peak). The presence of noise in a received light signal may cause that not all the peaks (not all the light pulses) of the associated adapted light signal may be distinguishable.

Due to attenuation on a communication channel over which an adapted light signal is received, not all of the sub-pulses (present in the emitted signal) may be visible in the detected signal, i.e. the amplitude of some sub-pulses may be low with respect to a noise floor (described in further detail below) such that they can no longer be distinguished from the noise (or at least they can no longer be easily distinguished from the noise). As shown in the graphs 150c, 150d in FIG. 1C and FIG. 1D, in the received light signal 154 only some of the light pulses of the adapted light signal 152 may be identifiable, e.g. only the first light pulse 156-1, the second light pulse 156-2, and the third light pulse 156-3 in this exemplary configuration. The remaining light pulses (e.g., the fourth light pulse 156-4 and the fifth light pulse 156-5) may be hidden by the noise 158. Stated differently, in this exemplary configuration three out of the five emitted sub-pulses (e.g., Gaussian sub-pulses) may be detected within the presence of the noise 158; two of the sub-pulses may be hidden by the noise 158 and may not be detected (may not be distinguished from the noise 158).

The method 100 may be based on determining the effect of the noise on a light signal (e.g., on the adapted light signal 152) by analyzing how much of the light signal gets lost, e.g. how many light pulses of the adapted light signal are no longer visible at reception due to the noise. By determining which light pulses (illustratively which peaks, or which signal levels) may be distinguished in a received light signal (e.g., in the received light signal 154), the noise level may be estimated. The signal levels of the light pulses that are hidden in the noise may provide an indication of the noise level in the received light signal.

Knowing the structure of an adapted light signal, the SNR of the detected signal may be estimated by verifying which pulses are visible in front of the background noise. Particularly considering a staircase signal (e.g., a declining or growing comb) including a decreasing or increasing sequence of sub-pulses (as described in further detail below), counting the pulses that are visible in front of the background noise may be sufficient to estimate the SNR of the detected signal. The problem of SNR estimation may reduce to a problem of pulse identification and counting which may be realized, for example, with comparators and counters, as described in further detail below. An advantage of this approach is that it does not require signal sampling to derive amplitude information which is instead needed to derive the SNR in an ADC-based solution. The approach described herein may provide a reduction of complexity and cost at the detector side.

In some aspects, the method 100 may include determining (e.g., estimating) an average signal level of the noise associated with a received light signal (also referred to herein as noise floor or average noise signal level). The method 100 may include analyzing the received light signal to determine noise information therefrom, e.g. to determine (e.g., to estimate) a background noise associated with the received light signal. The noise floor may include at least one of an average noise power, an average noise current, an average noise voltage, or an average noise amplitude. In the exemplary configuration illustrated in FIG. 1C and FIG. 1D, a noise floor 160 associated with an average noise power for the received light signal 154 may be determined. The noise floor may be used to provide amplitude information in combination with the estimated signal-to-noise ratio, as described in further detail below. In the exemplary configuration of FIG. 1C and FIG. 1D the noise floor 160 may be about −60 dBW.

In some aspects, additionally or alternatively to analyzing the received light signal, the noise floor may be estimated by using one or more noise parameters associated with the received light signal, such as a thermal noise, a shot noise, and the like. Illustratively, the method 100 may include determining the noise floor by analyzing one or more noise parameters of the scenario in which a light signal is received. The noise floor may be estimated using a measurement of secondary parameters. The noise present in the detected signal may strongly depend on temperature (thermal noise), ambient light (shot noise), and other factors. By measuring these parameters and using a suitable noise model an alternative for estimating the noise power may be provided, which may be easy to implement and accurate enough for the task at hand.

In some aspects, identifying the number of peaks in the received light signal may include comparing the received light signal with a threshold value (also referred to herein as threshold level). A peak (e.g., the associated light pulse) may be identified (and counted) in case the signal level of the received light signal at that peak is greater than the threshold value (in other words, in case the signal level of the received light signal at that peak is in a detection range defined by the threshold value). In case the signal level of the received light signal at a peak is less than the threshold value, the peak (e.g., the associated light pulse) may be indistinguishable from the noise, and may thus not be identified (and not counted). In the exemplary configuration shown in FIG. 1D, a threshold value 162 may be determined for the received light signal 154. The first light pulse 156-1 and the second light pulse 156-2 may have the respective first peak and second peak above the threshold value 162, illustratively a signal level (e.g., a power in the graph 150d in FIG. 1D) at the first peak and the second peak may be greater than the threshold value 162 (e.g., greater than a threshold power), such that those light pulses may be identified. The third light pulse 156-3, as well as the fourth light pulse 156-4 and the fifth light pulse 156-5, may have the respective third peak, fourth peak, and fifth peak below the threshold value, illustratively a signal level (e.g., a power) at the third peak, at the fourth peak, and at the fifth peak may be less than the threshold value 162 (e.g., less than the threshold power), such that those light pulses may not be identified and may be excluded from the count.

A threshold value (e.g., the threshold value 162) may be configured to reduce or prevent the possibility that part of the noise (e.g., peaks present in the noise) may be erroneously identified as part of the signal portion of a received light signal (e.g., of the received light signal 154). Illustratively, the threshold value may be selected such that all the noise of a received light signal falls below the threshold value.

The threshold value may be associated with a signal level associated with a received light signal, e.g. a threshold power (as shown in FIG. 1D), a threshold current, a threshold voltage, or a threshold amplitude. The threshold value may be selected such that the corresponding signal level of the noise of the received light signal is below the threshold value, e.g. such that an average noise power is below a threshold power, such that an average noise current is below a threshold current, such that an average noise voltage is below a threshold voltage, or such that an average noise amplitude is below the threshold amplitude. As shown in FIG. 1D, for this exemplary scenario, the threshold power 162 may be configured such that the noise 158 falls below the threshold value 162.

The threshold value may be fixed (in other words, predetermined or predefined), for example based on a known or expected noise of a received light signal (e.g., of the received light signal 154). The threshold value may be fixed based on known properties of a light signal, e.g. on known properties that an adapted light signal may have in absence of noise. As an example, the threshold value may be selected to be 10% lower than a corresponding lowest signal level of the adapted light signal (e.g., a threshold power may be selected 10% lower than a minimum power at the peaks of the adapted light signal), for example 30% lower than the corresponding lowest signal level, for example 50% lower than the corresponding signal level.

Additionally, or alternatively, the threshold value may be determined during runtime, i.e. the threshold value may be determined during and/or after receiving a light signal. The threshold value may be determined based on the actually received light signal, e.g. based on the actual noise associated with the received light signal, as described in further detail below.

In some aspects, the method 100 may include determining the threshold value by using the noise floor (e.g., determining the threshold value 162 based on the noise floor 160). The threshold value for the identification of the peaks may be selected in accordance with the average signal level of the noise. The threshold value may be selected greater than the noise floor, e.g. by an amount that ensures that noise is not considered in the identification of the peaks.

The method 100 may include determining the threshold value by adding an offset value to the noise floor (assuming a logarithmic scale), e.g. by adding an offset value to the average noise power, by adding an offset value to the average noise current, by adding an offset value to the average noise voltage, or by adding an offset value to the average noise amplitude. In some aspects, the offset value may be understood as a constant to be added to the noise floor. In some aspects, the method 100 may include determining the threshold value by multiplying the average signal level of the noise by an offset value (assuming a linear scale), e.g. by multiplying the average signal level of the noise by a scaling factor. The scaling factor may be greater than 1, e.g. 2, 4, 10, as examples. As a numerical example, the offset value may be 3 dB, for example 6 dB.

The offset value (and the scaling factor) may be selected to ensure that the identified peaks are actually associated with the signal portion of a received light signal and not with the noise. The offset value (and the scaling factor) may be selected such that the likelihood of a false trigger caused by the (random) background noise is smaller than a tolerable threshold, e.g. P<1e⁻³ as an example. The likelihood may be derived mathematically using further assumptions derived by characterization (e.g., Gaussian noise, known variance). In the exemplary configuration in FIG. 1D, an offset value 164 (e.g., 13 dB) may be added to the noise floor 160 to provide the threshold value 162.

In some aspects, the method 100 may include estimating the signal-to-noise ratio associated with a received light signal by using a preset (in other words, predefined) difference between respective signal levels associated with different peaks in the received light signal. Illustratively, the method 100 may include estimating the signal-to-noise ratio based on known differences between the signal levels associated with different peaks in an expected adapted light signal.

Different peaks (e.g., different light pulses) of an adapted light signal may have different properties, e.g. a different signal level at the peak, as will be described in further detail below (see also FIG. 2A to FIG. 2G). In the exemplary configuration in FIG. 1B, the adapted light signal 152 may include the first light pulse 156-1 having a first power at the first peak, the second light pulse 156-2 having a second power at the second peak, the third light pulse 156-3 having a third power at the third peak, the fourth light pulse 156-4 having a fourth power at the fourth peak, and the fifth light pulse 156-5 having a fifth power at the fifth peak. A difference between the signal levels at different peaks may be preset. In the adapted light signal 152, a difference between the power at different peaks may be 10 dB, which difference may be maintained among the peaks of the received light signal 154 (at an attenuated level with respect to the adapted light signal).

The signal-to-noise ratio associated with a received light signal may be estimated based on the number of identified peaks and on the known signal level associated therewith. Illustratively, based on the known lowest signal level that has been identified (or based on the known greatest signal level that has not been identified), an estimation of the signal-to-noise ratio may be provided. In the exemplary configuration shown in FIG. 1D, assuming a known difference between the signal levels of 10 dB and based on the identification of two light pulses, it may be inferred that the SNR associated with the received light signal 154 is at least 10 dB. Additionally taking into account the offset value of 13 dB, it may then be inferred that the SNR associated with the received light signal 154 is at least 10 dB+13 dB=23 dB (see also the further calculations below).

By denoting with K the number of identified peaks (e.g., the number of identified light pulses), with Δ the known difference between signal levels at different peaks in an adapted light signal, and with L the offset value (the difference between the threshold value and the noise floor), the signal-to-noise ratio may be estimated according to the equation below (assuming that L and Δ are logarithmic measures in dB, and the SNR is also estimated as logarithmic measure in dB),

SNR>=(K−1)*Δ+L (1)

Assuming a logarithmic scale, the method 100 may include estimating the signal-to-noise ratio associated with the received light signal by subtracting one to the number of identified peaks, multiplying the result of the subtraction by the known difference between the respective signal levels associated with different peaks (e.g., the known difference between the respective powers at different peaks), and adding the result of the multiplication to the offset value associated with the received light signal. In the exemplary scenario illustrated in FIG. 1D, K may be 2, Δ may be 10 dB, and L may be 13 dB, providing an estimated SNR of 23 dB, as described above.

In some aspects, the method 100 may include determining (e.g., estimating or calculating) a signal level at the peak of the received light signal having the greatest signal level (among the identified peaks) by using the estimated signal-to-noise ratio. The signal level at the peak may be determined by combining the estimated signal-to-noise ratio with the determined noise floor. The signal-to-noise ratio and the noise floor may be added to one another in case a logarithmic representation is used, or may be multiplied with one another in case a linear representation is used. In case of a logarithmic representation, a signal level at the peak having the greatest signal level may be determined as follows (assuming that the noise floor and SNR are logarithmic measures in dBW and dB, respectively, the signal level, e.g. the amplitude, may be estimated in dBW),

signal level>=SNR+noise floor (2)

Depending on the type of signal level, the power at the peak having the greatest power may be determined, the current at the peak having the greatest current may be determined, the voltage at the peak having the greatest voltage may be determined, or the amplitude of the peak having the greatest amplitude may be determined. In the exemplary configuration in FIG. 1D the power of the first light pulse 156-1 at the first peak may be estimated as (23 dB)+(−60 dBW)=<−37 dBW.

The SNR and amplitude information determined with the method 100 may be provided for further operations, for example in a LIDAR system, e.g. for assisting an object recognition process, for assisting a time-of-flight measurement, etc.

In various aspects, the configuration of an adapted light signal may not be limited, as long as the adapted light signal includes a plurality of peaks having different signal levels with respect to one another, e.g. as long as the adapted light signal includes a plurality of light pulses having different properties with respect to one another (e.g., different amplitude). A variety of multi-pulse signals may be suitable and may be used for the proposed TDC scheme.

FIG. 2A, FIG. 2B, FIG. 2C, FIG. 2D, FIG. 2E, FIG. 2F, and FIG. 2G each shows a respective graph 200a, 200b, 200C, 200d, 200e, 200f, 200g associated with a respective adapted light signal 202a, 202b, 202C, 202d, 202e, 202f, 202g according to various aspects. It is understood that the adapted light signals 202a, 202b, 202C, 202d, 202e, 202f, 202g (for brevity also referred to as 202a-202g) are only examples, and other configurations of an adapted light signal may be possible, e.g. with a different number of light pulses, with a different ordering of the light pulses, with different signal levels at the peaks, etc. In these graphs 200a, 200b, 200C, 200d, 200e, 200f, 200g an adapted signal is represented in terms of power in a linear scale (in W), for example in FIG. 2D and FIG. 2F, in terms of power in a logarithmic scale (in dBW), for example in FIG. 2A, FIG. 2B, FIG. 2C, FIG. 2E, or in terms of normalized power (in arbitrary units), for example in FIG. 2G. It is understood that similar considerations may apply in case the adapted light signal was represented in terms of another parameter (e.g., a current, or a voltage). The adapted light signals 202a-202g may be an example of the adapted light signal 152 described in relation to the method 100, e.g. in FIG. 1B.

An adapted light signal 202a-202g may include a plurality of light pulses 204a, 204b, 204c, 204d, 204e, 204f, 204g (for brevity also referred to as 204a-204g). Each light pulse of the plurality of light pulses 204a-204g may be associated with a respective peak (of a plurality of peaks). In the exemplary configurations shown in FIG. 2A to FIG. 2G: the adapted light signal 202a in FIG. 2A may include first to fifth light pulses 204a-1, 204a-2, 204a-3, 204a-4, 204a-5 (associated with first to fifth peaks); the adapted light signal 202b in FIG. 2B may include first to fifth light pulses 204b-1, 204b-2, 204b-3, 204b-4, 204b-5 (associated with first to fifth peaks); the adapted light signal 202C in FIG. 2C may include first to fifth light pulses 204c-1, 204c-2, 204c-3, 204c-4, 204c-5 (associated with first to fifth peaks); the adapted light signal 202d in FIG. 2D may include first to eighth light pulses 204d-1, 204d-2, 204d-3, 204d-4, 204d-5, 204d-6, 204d-7, 204d-8 (associated with first to eighth peaks); the adapted light signal 202e in FIG. 2E may include first to eighth light pulses 204e-1, 204e-2, 204e-3, 204e-4, 204e-5, 204e-6, 204e-7, 204e-8 (associated with first to eighth peaks); the adapted light signal 202f in FIG. 2F may include first to fifth light pulses 204f-1, 204f-2, 204f-3, 204f-4, 204f-5 (associated with first to fifth peaks); and the adapted light signal 202g in FIG. 2G may include first to fifth light pulses 204g-1, 204g-2, 204g-3, 204g-4, 204g-5 (associated with first to fifth peaks). In some aspects, an adapted light signal 202a-202g may be understood as an amplitude modulated light signal including a plurality of peaks.

The number of light pulses (and the associated number of peaks) in an adapted light signal may be selected arbitrarily (e.g., based on the capabilities of a light emission system). As a numerical example, an adapted light signal may include a number of light pulses in the range from 2 to 15, for example in the range from 2 to 10, for example in the range from 2 to 5. The number and the properties of the sub-pulses may be chosen according to the needs and targets of the proposed TDC solution. The number of sub-pulses may be denoted as N. It may be chosen taking into account the desired resolution of the SNR and amplitude estimation.

Each light pulse of an adapted light signal may have a respective shape, e.g. a rectangular shape, a square shape, a Gaussian shape, a sinusoidal shape, as examples. In the configuration shown in FIG. 2A to FIG. 2G, the light pulses 204a-204g of the adapted light signals 202a-202g may each have a Gaussian shape. In some aspects, each light pulse of an adapted light signal may have a same shape (as shown in FIG. 2A to FIG. 2G). In other aspects, an adapted light signal may include light pulses having different shapes, e.g. at least a first light pulse having a first shape and a second light pulse having a second shape different from the first shape. Stated in a different fashion, the individual sub-pulses may all have the same pulse shape (which may provide a simpler emission configuration), or may have different pulse shapes.

The different light pulses in an adapted light signal may have signal levels different from one another, e.g. at least one of a different power level at the peak (also referred to herein as peak power), a different current level at the peak (also referred to herein as peak current), a different voltage level at the peak (also referred to herein as peak voltage), or a different amplitude. To derive SNR and amplitude from time measurements, an adapted light signal may include sub-pulses that differ in amplitude (which in turns translates into a difference in power). The allocation of power onto the individual sub pulses may be performed in an arbitrary (but predefined) fashion, as described in further detail below.

An adapted light signal may include a first light pulse having a first signal level (at the associated first peak), a second light pulse having a second signal level (at the associated second peak), a third light pulse having a third signal level (at the associated third peak), etc. The first signal level may be different from the second signal level, e.g. may be greater than the second signal level or less than the second signal level. The third signal level may be different from the first signal level and the second signal level, e.g. may be greater than both, less than both, or may be at an intermediate level (e.g., greater than the first signal level and less than the second signal level, or vice versa). The same may apply to further light pulses and further signal levels (at the respective further peaks), e.g. a fourth signal level, a fifth signal level, etc.

As an example, an adapted light signal may include a first light pulse having a first peak power and a second light pulse having a second peak power different from the first peak power. The first peak power may be greater than the first peak power or may be less than the second peak power. Described differently, the first light pulse may have a first amplitude and the second light pulse may have a second amplitude different from the first amplitude, e.g. the first amplitude may be greater than the second amplitude or less than the second amplitude. As a further example, the adapted light signal may further include a third light pulse having a third peak power different form the first peak power and the second peak power, e.g. greater than the first peak power and the second peak power, or less than the first peak power and the second peak power, or at a power level between the first peak power and the second peak power. Described differently, the third light pulse may have a third amplitude different from the first amplitude and the second amplitude (e.g., greater than both, less than both, or at an intermediate amplitude level).

In the exemplary configurations illustrated in FIG. 2A to FIG. 2G, the light pulses 204a-204g of the adapted light signals 202a-202g shown therein may each have a respective power at the associated peak, which is different from the power at the respective peak of the other light pulses 204a-204g within the same adapted light signals 202a-202g.

In some aspects, the light pulses in an adapted light signal may be disposed in order of increasing or decreasing signal level (at the respective peak), e.g. an adapted light signal may have a stair-like or staircase configuration. Illustratively, in some aspects, a multi-pulse “staircase signal” may be provided (at the emitter side), e.g., an emitted ranging signal may include several pulses (sub-pulses), that have decreasing or increasing signal level (e.g., decreasing or increasing amplitude) from one sub-pulse to the next.

As shown for example in FIG. 2A, FIG. 2D, and FIG. 2E an adapted light signal 200a, 200d, 200e may include a plurality of light pulses arranged in order of decreasing signal level (e.g., in order of decreasing power), e.g. the respective first peak of the first light pulse 204a-1, 204d-1, 204e-1 may be at a first peak power greater than the second peak power of the respective second peak of the second light pulse 204a-2, 204d-2, 204e-2, the second peak power may be greater than a third peak power of the respective third peak of the third light pulse 204a-3, 204d-3, 204e-3, etc. The ordering may be understood as a temporal order, e.g. the light pulse having the greatest signal level may be the first emitted pulse, the second light pulse having the second greatest signal level may be the second emitted light pulse (emitted after the first light pulse), the third light pulse having the third greatest signal level may be the third emitted light pulse (emitted after the second light pulse), etc.

As shown for example in FIG. 2B, an adapted light signal 200b may include a plurality of light pulses arranged in order of increasing signal level (e.g., in order of increasing power), e.g. the first peak of the first light pulse 204b-1 may be at a first peak power less than the second peak power of the second peak of the second light pulse 204b-2, the second peak power may be less than the third peak power of the third peak of the third light pulse 204b-3, etc. The ordering may be understood as a temporal order, e.g. the light pulse having the lowest signal level may be the first emitted pulse, the second light pulse having the second lowest signal level may be the second emitted light pulse (emitted after the first light pulse), the third light pulse having the third lowest signal level may be the third emitted light pulse (emitted after the second light pulse), etc.

A configuration of an adapted light signal with light pulses disposed in order of decreasing signal level (as shown in FIG. 2A, FIG. 2D, and FIG. 2E) may be provided, for example, in case the first light pulse (having the greatest signal level) is assigned to an operation to be performed, e.g. in case the first light pulse is used for ranging, data transmission, etc.

In some aspects, as shown for example in FIG. 2C, FIG. 2F, and FIG. 2G an adapted light signal 200C, 200f, 200g may include a plurality of light pulses 204c, 204f, 204 disposed in random order, e.g. the respective second peak of the second light pulse 204c-2, 204f-2, 204g-2 may be at a second peak power greater than the third peak power of the respective third peak of the third light pulse 204c-3, 204f-3, 204g-3, and the third peak power may be less than the fourth peak power of the respective fourth peak of the fourth light pulse 204c-4, 204f-4, 204g-4, etc. The ordering of the light pulses within an adapted light signal may be chosen freely as long as light pulses with different signal levels are provided.

In some aspects, a difference in signal level between consecutive light pulses may be selected in accordance with a desired resolution of the estimation of the signal-to-noise ratio. In case an adapted light signal is configured as a staircase signal, the difference in signal level between consecutive light pulses may be referred to as step-size. The difference in signal level may be one of a difference in peak power, peak current, peak voltage, or amplitude. In case of stair-like signals the step-size Δ may relate, for example, to a difference in amplitude, or a difference in power between two consecutive sub-pulses. The step-size may be in logarithmic scale or in linear scale, as described in further detail below. Taking into account general system design and system complexity considerations, the number of sub-pulses and the step size Δ may be chosen to satisfy the desired SNR or amplitude estimation capabilities.

In some aspects, a difference in signal level between consecutive light pulses may remain constant throughout the plurality of light pulses, e.g. the staircase signal may increase or decrease by steps of constant step-size. As an example, an adapted light signal may include a first light pulse having a first peak power (and a first amplitude), a second light pulse having a second peak power (and a second amplitude), and a third light pulse having a third peak power (and a third amplitude). A difference between the first peak power and the second peak power may be equal to a difference between the second peak power and the third peak power. Illustratively, a difference between the first amplitude and the second amplitude may be equal to a difference between the second amplitude and the third amplitude.

As a numerical example, a difference in peak power between consecutive light pulses (e.g., between a first light pulse and a second light pulse, adjacent to one another, etc.) may be (in logarithmic scale) in the range from 3 dB to 20 dB, for example in the range from 6 dB to 10 dB, for example equal to or less than 10 dB.

As another numerical example, a difference in peak power between consecutive light pulses may be (in linear scale) be expressed by a factor in the range from 2 to 100, for example in the range from 4 to 10, for example by a factor greater than 2.

In some aspects, the difference in signal level between consecutive light pulses may be expressed by percentages. As an example, the signal level of each light pulse may be expressed in relation to the signal level of the light pulse having the greatest signal level (e.g., in relation to the signal level of the main pulse of the light signal). As a numerical example, the percentage variation with respect to the main pulse between different light pulses may be in the range from 5% to 90%, for example in the range from 10% to 60%.

By way of example, in case of a decreasing staircase signal, the signal level (e.g., the peak power) of consecutive light pulses may decrease by a certain percentage with respect to the first (main) light pulse. For example, the signal level (e.g., the peak power) of the second light pulse may be 90% of the signal level of the first light pulse, the signal level of the third light pulse may be 80% of the signal level of the first light pulse, the signal level of the fourth light pulse may be 70% of the signal level of the first light pulse, etc. As another example, in case of an increasing staircase signal, the signal level (e.g., the peak power) of consecutive light pulses may increase by a certain percentage with respect to the last (main) light pulse. For example, the signal level (e.g., the peak power) of the first light pulse may be 10% of the signal level of the last light pulse, the signal level of the second light pulse may be 20% of the signal level of the last light pulse, the signal level of the third light pulse may be 30% of the signal level of the last light pulse, etc. A step-size may be expressed in percentage terms, for example a step-size may include a variation (e.g., an increase or a decrease) in signal level between consecutive light pulses in the range from 10% to 50%, for example 12.5%. Illustratively, a signal level of a light pulse may have a variation in the range from 10% to 50% in relation to the main light pulse with respect to the signal level of the immediately preceding light pulse.

As an example a second peak power of a second light pulse may be equal to or less than 90% of a first peak power of a first light pulse (immediately preceding the second light pulse). As another example, a second peak power of a second light pulse may be equal to or more than 110% of a first peak power of a first light pulse (immediately preceding the second light pulse)

In the exemplary configuration shown in FIG. 2A and FIG. 2B, the adapted light signals 202a, 202b may be configured such that a peak power between consecutive light pulses decreases by a constant amount Δ (see FIG. 2A) or increases by a constant amount (see FIG. 2B), e.g. the same step-size Δ may be provided between the first peak power of the first light pulse 204a-1, 204b-1 and the second peak power of the second light pulse 204a-2, 204b-2, between the second peak power and the third peak power of the third light pulse 204a-3, 204b-3, between the third peak power and the fourth peak power of the fourth light pulse 204a-4, 204b-4, and between the fourth peak power and the fifth peak power of the fifth light pulse 204a-5, 204b-5. In this exemplary configuration the step-size Δ may be 10 dB.

In the exemplary configuration shown in FIG. 2D (in linear scale) the adapted light signals 202d may be configured such that a peak power between consecutive light pulses decreases by a constant amount δ (in linear scale, not shown in FIG. 2D). The same step-size δ may be provided between the first peak power of the first light pulse 204d-1 and the second peak power of the second light pulse 204d-2, between the second peak power and the third peak power of the third light pulse 204d-3, between the third peak power and the fourth peak power of the fourth light pulse 204d-4, and between the fourth peak power and the fifth peak power of the fifth light pulse 204d-5. In this exemplary configuration the step-size δ may be 0.125, illustratively a percentage variation of 12.5% in relation to the main pulse (in this example the first pulse 204d-1) between consecutive light pulses 204d. Illustratively, in the exemplary configuration illustrated in FIG. 2D the signal levels of the light pulses 204 may be as follows, assuming a signal level MS for the main pulse 204d-1: the second light pulse 204d-2 may have a signal level of MS*(1-1*0.125), the third light pulse 204d-3 may have a signal level of MS*(1-2*0.125), the fourth light pulse 204d-4 may have a signal level of MS*(1-3*0.125), etc. The constant step-size in linear scale may provide a varying step-size in logarithmic scale, as shown in FIG. 2E, in which the adapted light signal 202e may correspond to the adapted light signal 202d of FIG. 2D plotted in logarithmic scale.

In case of a randomly ordered adapted light signal 202C, 202f, 202g (see FIG. 2C, FIG. 2F, and FIG. 2G), the step-size may be understood as the difference between consecutive signal levels rather than between consecutive light pulses. Illustratively, an adapted light signal 202C, 202f, 202g including randomly ordered light pulses may include a plurality of signal levels (e.g., a first signal level, a second signal level, a third signal level, etc.) and a difference between consecutive signal levels may be defined by the step-size (e.g., the difference between the first signal level and the second signal level, the difference between the second signal level and the third signal level, etc.). Each signal level may be associated with a respective light pulse according to the random distribution of the light pulses within the light signal.

In some aspects, a spacing between consecutive light pulses in an adapted light signal may be adjusted in accordance with a desired operation to be carried out with the adapted light signal. A spacing between consecutive light pulses may be understood as a time difference between two consecutive light pulses. The spacing may also be referred to herein as sub-pulse duration. The spacing between consecutive light pulses may be in the range from 50 ps to 50 ns, for example in the range from 50 ps to 500 ns. A short or relatively shorter spacing may be preferred, e.g. in case of a time-of-flight measurement to be carried out with the adapted light signal to allow a faster scanning of the scene. The spacing between consecutive light pulses may be a peak to peak distance (in time) between consecutive light pulses (e.g., between consecutive peaks).

The sub-pulses may either be equally spaced in time, or may have an unequal spacing in time. In some aspects, the spacing between consecutive light pulses may be constant throughout the light pulses of an adapted light signal. Illustratively, a first spacing (a first peak to peak distance) between a first light pulse and a second light pulse may be equal to a second spacing (a second peak to peak distance) between the second light pulse and a third light pulse, etc. The second pulse may be immediately subsequent to the first light pulse, and the third light pulse may be immediately subsequent to the second light pulse. In the exemplary configuration shown in FIG. 2A all pulses may be equally spaced, e.g. the spacing Tₛ between the first light pulse 204a-1 and the second light pulse 204a-2 may be equal to the spacing between the second light pulse 204a-2 and the third light pulse 204a-3, equal to the spacing between the third light pulse 204a-3 and the fourth light pulse 204a-4, and equal to the spacing between the fourth light pulse 204a-4 and the fifth light pulse 204a-5. In the exemplary configuration in FIG. 2A, the spacing between consecutive light pulses may be 6 ns. The same may apply to the adapted light signals 202b-202g shown in FIG. 2B to FIG. 2G.

In some aspects, the spacing between consecutive light pulses may vary throughout the light pulses of an adapted light signal. Illustratively, a first spacing (a first peak to peak distance) between a first light pulse and a second light pulse may be different with respect to a second spacing (a second peak to peak distance) between the second light pulse and a third light pulse, etc.

In some aspects, a duration of a light pulse, e.g. a full width at half maximum of a light pulse, of an adapted light signal may be adjusted in accordance with a desired operation to be carried out with the adapted light signal. A duration of a light pulse may be in the range from ns to 5 ns, for example in the range from 1 ns to 2 ns. The duration of different light pulses may remain constant throughout an adapted light signal or may vary between different light pulses of an adapted light signal. As an example, a first light pulse may have a first duration and a second light pulse may have a second duration equal to the first duration. Illustratively, an adapted light signal may include a plurality of light pulses each having a same duration. As another example, a first light pulse may have a first duration and a second light pulse may have a second duration different form the first duration. Illustratively, an adapted light signal may include a plurality of light pulses and at least two light pulses may have duration different from one another.

In the exemplary configuration shown in FIG. 2A all pulses may have a same duration, e.g. the first duration of the first light pulse 204a-1 may be equal to the second duration of the second light pulse 204a-2, equal to the third duration of the third light pulse 204a-3, equal to the fourth duration of the fourth light pulse 204a-4, and equal to the fifth duration of the fifth light pulse 204a-5. In the exemplary configuration in FIG. 2A, the duration of a light pulse may be about 1.5 ns. The same may apply to the adapted light signals 202b-202g shown in FIG. 2B to FIG. 2G.

In various aspects, an adapted light signal may be configured for carrying out a desired operation in addition to providing the possibility of estimating SNR and amplitude. As an example, an adapted light signal may be configured for a ranging operation (e.g., for measuring a distance to an object in a LIDAR system). An adapted light signal may be used for ranging, e.g. an adapted light signal may be a ranging signal, and the received light signal may be a direct reflection of the adapted light signal originating from the scene. A direct time-of-flight (ToF) measurement may be carried out by emitting a ranging signal, e.g. configured as a staircase signal including several light pulses (several sub pulses), and waiting for its reflection to return. The detected signal, if any is detected, may be a filtered and attenuated version of the emitted signal additionally corrupted by additive noise (as described for example in relation to FIG. 1C and FIG. 1D above).

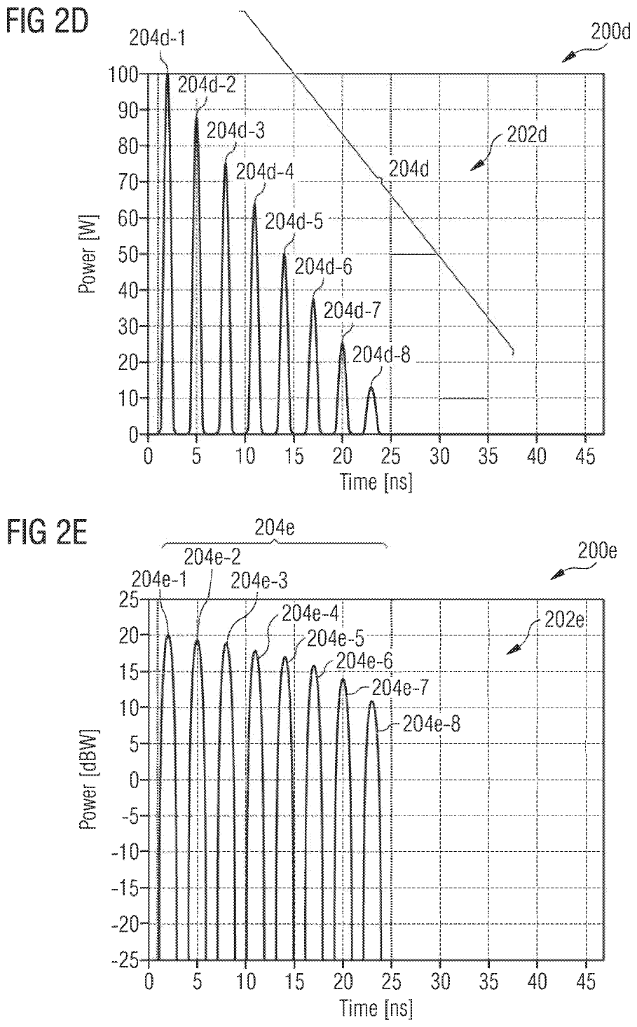

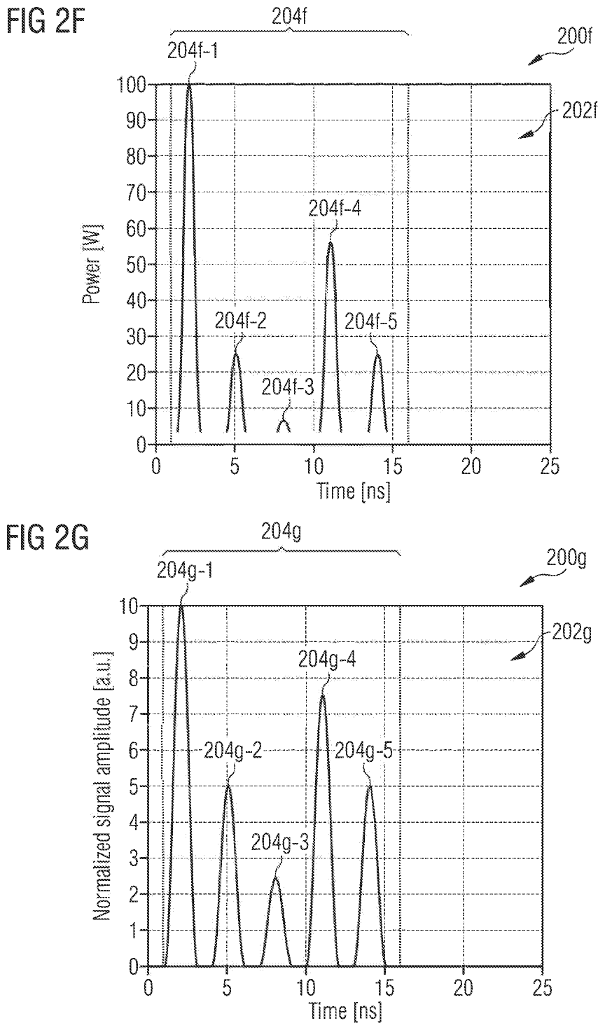

In some aspects, only one of the light pulses of an adapted light signal, e.g. the light pulse having the greatest signal level associated therewith (also referred to herein as main pulse), may be configured for (or dedicated to) the desired operation. As an example, the method 100 described in relation to FIG. 1A may include determining a time-of-flight associated with a received light signal based on the arrival time of the light pulse having the greatest signal level among the light pulses of the received light signal. In other aspects, the entire adapted light signal (illustratively, all the light pulses thereof) may be configured for (or dedicated to) the desired operation, e.g. for ranging. These two implementations will now be described, as an example, in relation to FIG. 3A, FIG. 3B, and FIG. 3C.

FIG. 3A, FIG. 3B, FIG. 3C each shows a respective graph 300a, 300b, 300c associated with an adapted light signal 302a (FIG. 3A) or a received light signal 304b, 304c (FIG. 3B and FIG. 3C). In the graphs 300a, 300b, 300c, the horizontal axis (the x-axis) may be associated with the time (in ns), and the vertical axis (the y-axis) may be associated with the power (in a logarithmic scale, in dBW). It is understood that the adapted light signal 302a described in relation to FIG. 3A, and the received light signal 304b, 304c described in relation to FIG. 3B and FIG. 3C are only an example, and light signals having a different shape or configuration may be provided, as described, for example, in relation to FIG. 2A to FIG. 2G.

In the exemplary configuration shown in FIG. 3A, the adapted light signal 306a may include a plurality of light pulses 306a (e.g., N=5 sub-pulses), e.g. first to fifth light pulses 306a-1, 306a-2, 306a-3, 306a-4, 306a-5 (associated with respective first to fifth peaks). In the configuration in FIG. 3A the adapted light signal 306a may be configured as a decreasing staircase, in which the first light pulse 306a-1 may have the greatest signal level among the plurality of light pulses 306a (e.g., a greatest peak power), i.e. the first light pulse 306a-1 may be the main pulse of the adapted light signal 302a.

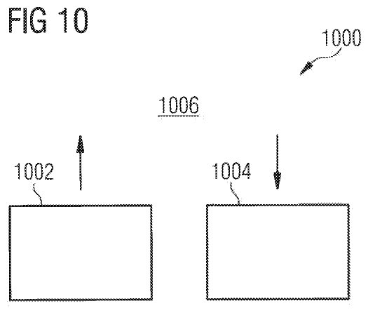

In case the adapted light signal 302a is to be used for measuring a time-of-flight, in the most straightforward implementation only the main pulse is used for ranging. The energy in the other light pulses (the other 4 sub-pulses in this exemplary configuration) is not used for ranging but only for channel estimation, e.g. only for SNR estimation. From a ranging perspective the energy collected in the other emitted pulses is lost, which may be disadvantageous. However, it may be noted that the SNR usually only needs to be known with a relatively low granularity. Furthermore, often a logarithmic scale is sufficient. As a result, the energy collected in the sub-pulses that are next to the main pulse is relatively low when compared to the energy contained in the main pulse. As a numerical example, assuming a step-size of 6 dB, and an adapted light signal 306a with one main pulse and four additional channel estimation pulses (covering a dynamic range of 24 dB), the wasted energy/power may be about 24.93%. As another numerical example, assuming a step-size of 10 dB, and an adapted light signal 306a with one main pulse and four additional channel estimation pulses (covering a dynamic range of 40 dB), the wasted energy/power may be 11.11%. Thus the energy loss, although not negligible, may be acceptable considering the benefits that SNR information may bring for a system as a whole. Particularly the usage of adaptive ranging schemes (that may become available through SNR information) may help to improve power consumption despite the multi-pulse scheme (with the associated power inefficiency), as described in further detail below, for example in relation to FIG. 10.

In some aspects, all the energy collected in a multi-pulse signal (and not only the energy contained in the main pulse) may be used for the desired operation, e.g. for ranging. This may provide an improved performance (e.g., an improved ranging performance) at a given power consumption, or an improved power consumption for the given operation (e.g., for a given target range).

In FIG. 3B an implementation is illustrated, in which only the main pulse of an adapted light signal (e.g., only the first pulse 306a-1 of the adapted light signal 302a) may be used for the desired operation. In FIG. 3C an implementation is illustrated, in which one or more pulses of an adapted light signal (e.g., all the pulses 306a of the adapted light signal 302a) may be used for the desired operation.

In the implementation illustrated in FIG. 3B only the main pulse of the received light signal 304b (e.g., the first pulse 306b-1) may be considered for the desired operation, e.g. for a time-of-flight measurement. The other pulses of the received light signal 304b (e.g., second to fifth light pulses 306b-2, 306b-3, 306b-4, 306b-5) may be used only for estimating the SNR, as described above in relation to FIG. 1A to FIG. 1D. In this exemplary configuration, the SNR (as indicated by the arrow 308b) may be about 14.7 dB (e.g., considering a noise floor 310b of about −59.47 dBW).

In the implementation illustrated in FIG. 3C the entire received light signal 304b is further processed yielding the received light signal 304c (which itself is a multi-pulse signal with light pulses 306c-1, 306c-2, 306c-3, 306c-4, 306c-5, 306c-6, 306c-7, 306c-8, 306c-9). The greatest peak in the received light signal 304c may then be used for the desired operation, e.g. for a time-of-flight measurement. In this exemplary configuration, the SNR (as indicated by the arrow 308c) may increase with respect to the implementation shown in FIG. 3B, e.g. the SNR may be about 16.5 dB (e.g., considering a noise floor 310c of about −53.06 dBW). The ranging performance may be improved. In FIG. 3C, S²_{RX} may refer to the light signal, N g to the noise, and S_{RX}+N_{g} to the combination of signal and noise (illustratively, to the noisy version of the light signal).

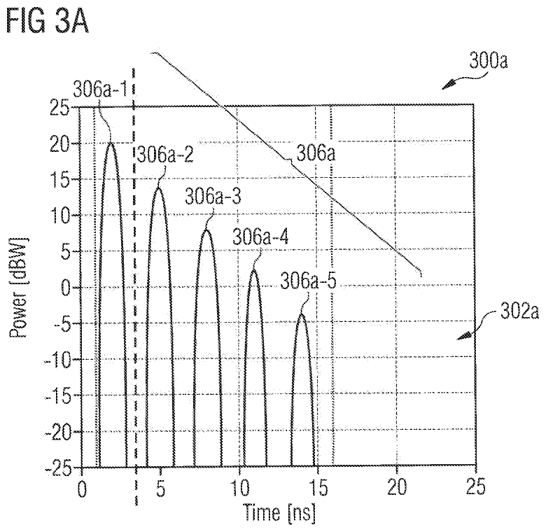

In the following, e.g. in relation to FIG. 4 to FIG. 10, possible practical implementations of the method 100 described in relation to FIG. 1A will be described, e.g. systems and components configured to put the method 100 (or parts thereof) into practice.

FIG. 4 shows a light detection system 400 (also referred to herein as light detection device 400) in a schematic view according to various aspects. The light detection system 400 may be configured to carry out the method 100 described in relation to FIG. 1A. In some aspects, the light detection system 400 may be a light detection system configured according to a time-to-digital conversion approach, as described in further detail below.

The light detection system 400 may include a detector 402 configured to provide a received light signal 404. Illustratively the detector 402 may be configured to receive (or the detect) a light signal 404 and to provide a representation of the received light signal 404, e.g. to provide an analog signal (e.g., a current or a voltage, as described in further detail below) associated with the light signal 404 received at the detector 402. Illustratively, the detector 402 may be configured to implement the aspect 110 of the method 100 described in relation to FIG. 1A.

The light signal 404 received at the detector 402 may be a noisy version of an adapted light signal, e.g. of an adapted light signal configured as described for the adapted light signals 152, 202a-202g, 3020 described in relation to FIG. 1B, FIG. 2A to FIG. 2G, and FIG. 3A above. Illustratively, the light signal 404 received at the detector 402 may be a received light signal configured as the received light signal 154, 304b, 304c described in relation to FIG. 1C, FIG. 1D, FIG. 3B, and FIG. 3C above. The light signal 404 may be configured for both a desired operation (e.g., ranging, for a ToF measurement) and for a SNR estimation.

The light detection system 400 may include a processing circuit 406 coupled with the detector 402. The processing circuit 406 may be configured to receive from the detector 402 the received light signal 404 (a representation of the light signal 404 received at the detector 402 that the processing circuit 406 may process).

The processing circuit 406 may be configured to identify a number of peaks in the received light signal 404 (illustratively, the processing circuit 406 may be configured to process the received light signal 404 to identify the number of peaks in the received light signal 404). Stated in a different fashion, the processing circuit 406 may be configured to count the number of distinguishable peaks in the received light signal 404. In some aspects, the processing circuit 406 may be configured to identify a number of light pulses in the received light signal 404.

In some aspects, the processing circuit 406 may be configured to provide a digitized representation of the received light signal 404. The processing circuit 406 may be configured to convert the received light signal via time-to-digital conversion to provide the digitized representation of the received light signal 404. A representation of the received light signal 404 provided via time-to-digital conversion may include a binary representation indicating the presence/absence of received light over time (e.g., indicating the presence/absence of received light pulses of the received light signal 404 over time).

The processing circuit 406 may be further configured to estimate a signal-to-noise ratio associated with the received light signal 404 based on the number of identified peaks illustratively, by using the number of identified peaks, or in accordance with the number of identified peaks. In some aspects, the processing circuit 406 may be further configured to estimate a signal-to-noise ratio associated with the received light signal 404 based on the number of identified light pulses in the received light signal 404.

In some aspects, the processing circuit 406 may be further configured to estimate a signal level (e.g., an amplitude) of at least one light pulse of the identified light pulses, e.g. of at least one peak of the received light signal 404, as described in further detail below.

By way of illustration, the processing circuit 406 may be configured to implement the aspects 120, 130 of the method 100 described in relation to FIG. 1A.

The light detection system 400 may thus provide the advantages of a simple TDC-based system while providing information about SNR (and amplitude) on top. As an example, the number of expensive components may be reduced compared to an ADC-based approach, while being suitable for high-speed implementations. As compared to waveform sampling solutions, no high-speed ADC may be needed, which may be beneficial with respect to power consumption and cost. The event-based nature (presence/absence) of TDC detection schemes may enable reducing the amount of generated data, leading to less data to be processed process (e.g., leading to a reduced CPU load), and less CPU-power is needed, thus reducing power consumption and cost of the system. The information about SNR and amplitude that may be provided by the light detection system 400 provides meaningful information about the measurement for subsequent data processing stages (e.g., object detection, object tracking, sensor fusion, as examples for a LIDAR system). In addition, the detector 402 may be realized with low complexity.

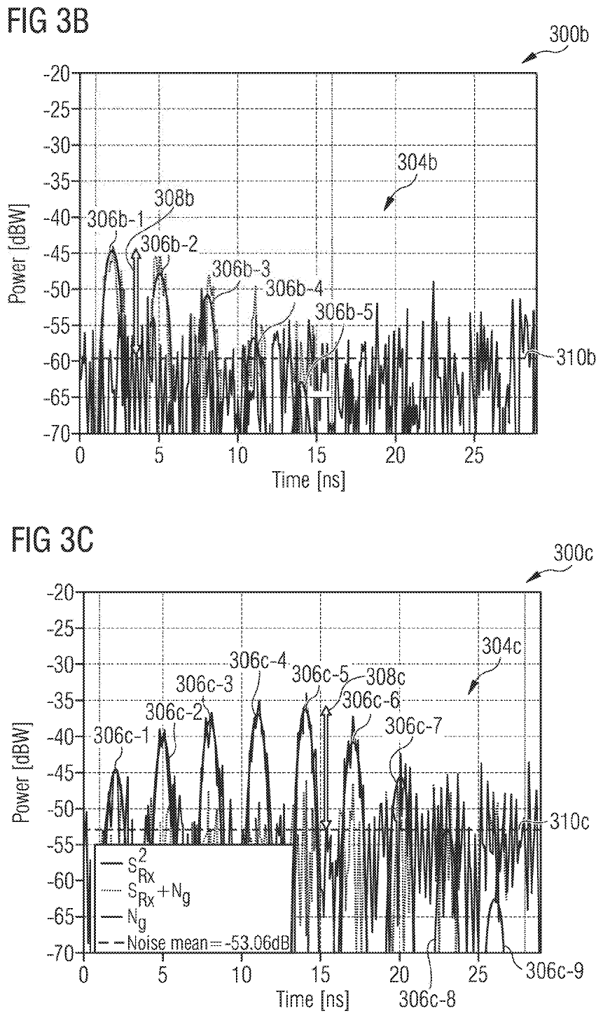

In the following, in relation to FIG. 5 to FIG. 8C, possible components and configurations of the detector 402 and of the processing circuit 406 are illustrated. It is understood that the configurations and the components described herein are exemplary, and other configurations (e.g., with additional, less, or alternative components) may be provided to carry out the method 100 described in relation to FIG. 1A.

FIG. 5 shows a detector 500 in a schematic view according to various aspects. The detector 500 may be an exemplary realization of the detector 402 described in relation to FIG. 4.

The detector 500 may include a photo diode 502 configured to provide an analog signal in response to light impinging onto the photo diode 502. The photo diode 502 may be configured to provide an analog signal (a first analog signal of a first type, e.g., a current, such as a photo current) in response to a received light signal (e.g., the received light signal 404) impinging onto the photo diode 502. As examples, the photo diode 502 may include at least one of a PIN photo diode, an avalanche photo diode, a single photo avalanche diode, or a silicon photomultiplier.

In some aspects, the detector 500 may include a plurality of photo diodes 502 (e.g., of the same type or of different types), illustratively, the detector 500 may include a plurality of pixels each including or associated with a respective photo diode 502. In this configuration, the plurality of photo diodes 502 may form an array, e.g. a one-dimensional or two-dimensional array. Illustratively, the photo diodes 502 may disposed along one direction (e.g., a vertical direction or a horizontal direction), or may disposed along two directions, e.g. a first (e.g., horizontal) direction and a second (e.g., vertical) direction.

In some aspects, the photo diode 502 may be configured to provide a signal for each photon (e.g., for each individual photon) impinging on the photo diode 502, for example in case the photo diode 502 includes a silicon photomultiplier array including one or more SPADs.

In some aspects, the photo diode 502 may be configured to provide an aggregate analog signal representing the arrival of one or more photons at the photo diode 502 over one or more time intervals. Illustratively, the photo diode 502 may be configured to provide an aggregate distribution representing the photons arrived at the photo diode 502 over a certain time interval. The aggregate analog signal may be processed to identify the peaks in the received light signal. A processing circuit coupled with the detector 500 (e.g., the processing circuit 406) may be configured to generate an aggregate digitized signal by using the aggregate analog signal, and may be configured to identify the one or more peaks in a received light signal (e.g., in the received light signal 404) based on the aggregate digitized signal.

The detector 500 may further include an amplifier circuit 504 coupled with the photo diode 502. The amplifier circuit 504 may be configured to receive the (first) analog signal provided by the photo diode 502, and may be configured to amplify the received analog signal. The amplifier circuit 504 may be configured to provide a (second) analog signal by amplifying the received (first) analog signal.

In some aspects, the amplifier circuit 504 may be configured to change a type of the received analog signal, e.g. from a current to a voltage or vice versa. Illustratively, the amplifier circuit 504 may be configured to provide a second analog signal of a second type based on the received first analog signal of a first type.

The amplifier circuit 504 may include at least one of a current amplifier, a voltage amplifier, or a power amplifier. As examples, the amplifier circuit 504 may include a transistor amplifier, an operational amplifier, or a transimpedance amplifier.

The photo diode 502 and the amplifier circuit 504 may provide a received light signal at an output 506 of the detector 500 (e.g., at an output coupled with a processing circuit, e.g. with the processing circuit 406), illustratively an analog (and amplified) representation of a light signal arriving at the photo diode 502.

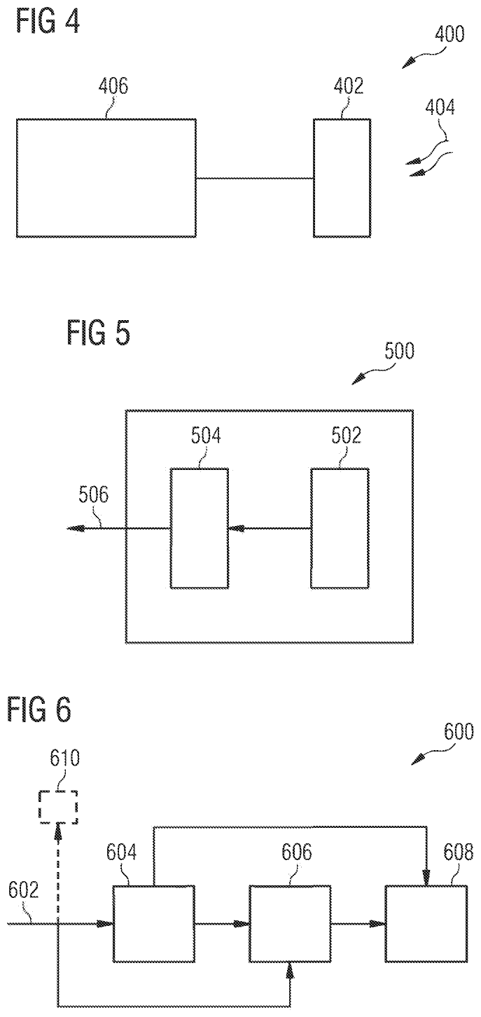

FIG. 6 shows a processing circuit 600 in a schematic view according to various aspects. The processing circuit 600 may be an exemplary realization of the processing circuit 406 described in relation to FIG. 4.

The processing circuit 600 may be configured to receive a signal at an input 602, e.g. may be configured to receive a received light signal at the input 602 (e.g., the received light signal 404), for example an analog representation of a received light signal (e.g., as provided by the detector 500 described in relation to FIG. 5).

The processing circuit 600 may illustratively include a plurality of processing stages, in which the received light signal is processed, leading to the estimation of the signal-to-noise ratio associated with the received light signal. The various processing stages may be configured to implement the various aspects of the method 100 described in relation to FIG. 1A. In some aspects, the processing circuit 600 may include a threshold determination circuit 604, a peak identification circuit 606, and a SNR estimation circuit 608. Various operations described herein in relation to a processing circuit (e.g., to the processing circuit 406, 600) may be understood to be carried out by a corresponding sub-circuit of the processing circuit.

The threshold determination circuit 604, the peak identification circuit 606, and the SNR estimation circuit 608 may be coupled with one another, such that an exchange of information may be carried out among the various processing stages.

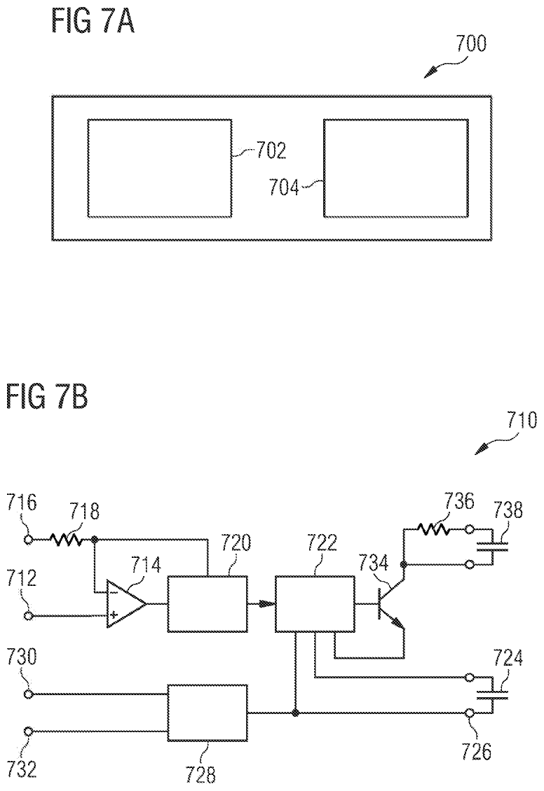

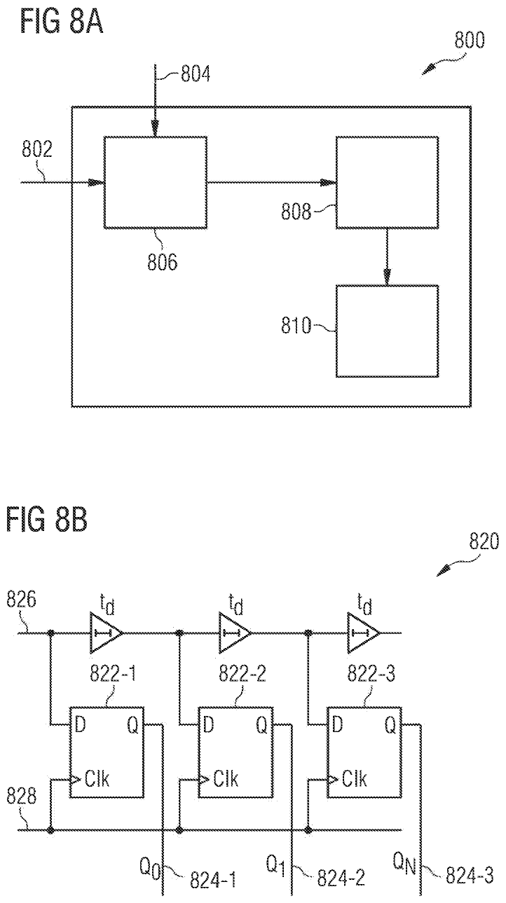

The threshold determination circuit 604 may be configured to determine a threshold value associated with the received light signal, and to provide the determined threshold value to the peak identification circuit 606 and to the SNR estimation circuit 608 (to be taken into account in determining the SNR, as described in equation (1)). An operation of the threshold determination circuit 604 will be described in further detail below, e.g. in relation to FIG. 7A and FIG. 7B. The threshold determination circuit 604 may be configured to determine a noise floor associated with the received light signal, and to determine the threshold value in accordance with the determined noise floor. The threshold determination circuit 604 may be configured to provide noise floor information to the SNR estimation circuit 608 (to be taken into account in determining the signal level of a peak, as described in equation (2)).

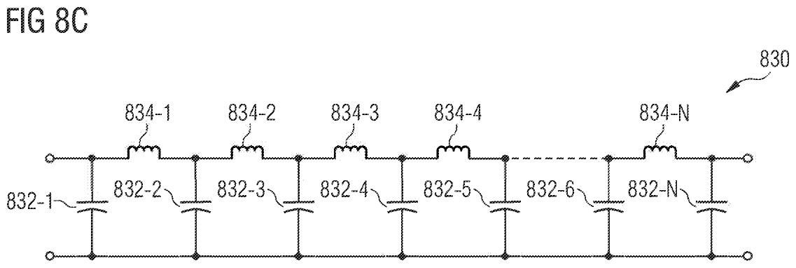

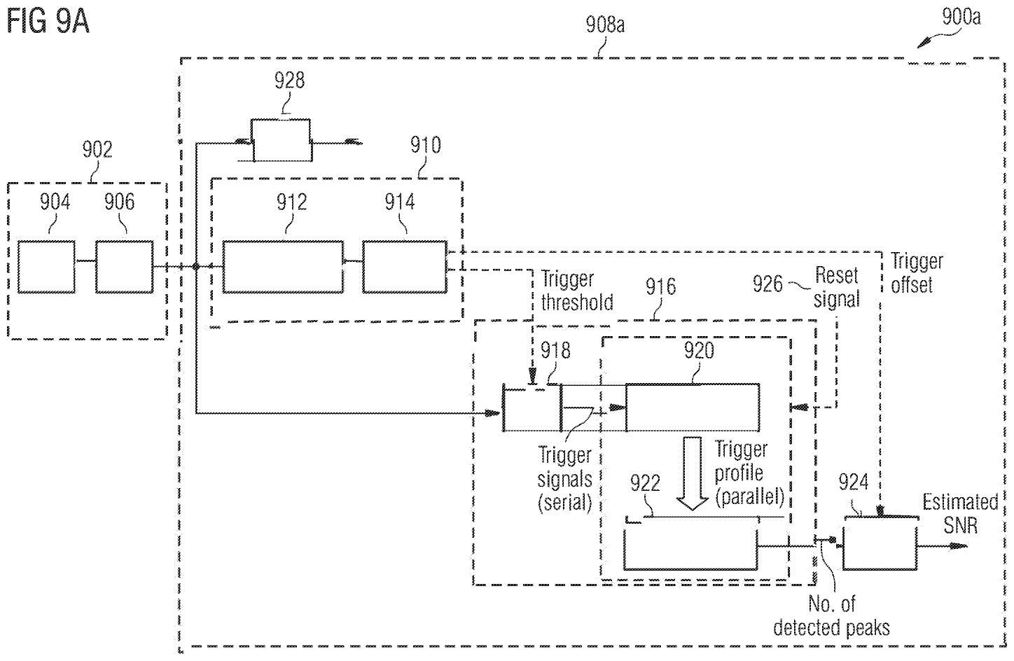

The peak identification circuit 606 may be configured to identify a number of peaks in the received light signal, and to provide information on the number of identified peaks to the SNR estimation circuit 608 (to be taken into account in determining the SNR, as described in equation (1)). The peak identification circuit 606 may be configured to receive the received light signal (from the input 602) and to receive threshold information (from the threshold determination circuit 604), and may be configured to identify the number of peaks in the received light signal in accordance with the received threshold information. An operation of the threshold determination circuit 604 will be described in further detail below, e.g. in relation to FIG. 8A and FIG. 8C.

The SNR estimation circuit 608 may be configured to determine (e.g., to estimate or calculate) the signal-to-noise ratio associated with the received light signal, e.g. in accordance with the received information. The SNR estimation circuit 608 may be configured to receive threshold information (from the threshold determination circuit 604) and information on the number of identified peaks (from the peak identification circuit 606), and to determine the SNR accordingly (e.g., as described in equation (1)). The SNR estimation circuit 608 may include one or more processors configured to determine the signal-to-noise ratio associated with the received light signal based on the received information.

In some aspects, the processing circuit 600 (e.g., at the SNR estimation circuit 608) may be configured to estimate the signal-to-noise ratio associated with the received light signal by using a preset difference between respective signal levels associated with different peaks in the received light signal, e.g. as described in relation to equation (1). The processing circuit 600 (e.g., the SNR estimation circuit 608) may be configured to receive information describing a light signal (an adapted light signal) associated with the received light signal, i.e. information describing an expected configuration of the received light signal in absence of noise. In some aspects, the processing circuit 600 may include a memory storing known information on a received light signal (and on an adapted light signal). In other aspects, the processing circuit 600 may be coupled with a memory storing such information and may be configured to retrieve it upon determination of the signal-to-noise ratio. In other aspects, the processing circuit 600 may be configured to receive such information from a light emission system that emitted the light signal, or from a central processing circuit coupled to the light emission system and to the processing circuit 600.

In some aspects, the processing circuit 600 (e.g., at the SNR estimation circuit 608) may be configured to estimate the signal-to-noise ratio associated with the received light signal by using a preset difference between the signal levels at the respective peaks of different light pulses in the received light signal. As an example, in case the received light signal includes at least a first peak having a first peak power and a second peak having a second peak power different from the first peak power (e.g., a first light pulse having a first power at the associated first peak, and a second light pulse having a second power at the associated second peak), the processing circuit 600 (e.g., at the SNR estimation circuit 608) may be configured to estimate the signal-to-noise ratio associated with the received light signal by using a preset difference between the first peak power and the second peak power.

In some aspects, assuming a logarithmic representation, the processing circuit 600 (e.g., at the SNR estimation circuit 608) may be configured to estimate the signal-to-noise ratio associated with the received light signal by subtracting one to the number of identified peaks, multiplying the result of the subtraction by the known difference between the respective powers associated with different peaks, and adding the result of the multiplication to the threshold value.

In some aspects, the processing circuit 600 (e.g., at the SNR estimation circuit 608) may be configured to estimate a signal level of at least one peak of the identified peaks in the received light signal. The processing circuit 600 may be configured to estimate the signal level of the peak having the greatest signal level among the identified peaks in the received light signal. The processing circuit 600 may be configured to estimate the signal level of the at least one peak (e.g., the signal level of at least one light pulse at the associated peak) by using the estimated signal-to-noise ratio, for example as described in equation (2). The processing circuit 600 may be configured to estimate the signal level by combining the estimated signal-to-noise ratio with the determined noise floor. The processing circuit 600 may be configured to estimate the signal level by adding the noise floor to the signal-to-noise ratio, in case a logarithmic representation is used, or may be configured to estimate the signal level by multiplying the noise floor by the signal-to-noise ratio in case a linear representation is used.

In some aspects, the processing circuit 600 may be configured to determine (e.g., estimate or calculate) a time-of-flight associated with the received light signal, for example in case the processing circuit 600 is part of a LIDAR system.

The processing circuit 600 may be configured to generate a trigger signal in response to the received light signal. In some aspects, the trigger signal may be generated in the peak identification circuit 606, as described in further detail below. In other aspects, the processing circuit 600 may optionally include a trigger circuit 610 (a ToF trigger, for example a Schmitt trigger) configured to provide the trigger signal upon reception of the received light signal. In some aspects, the processing circuit 600 (e.g., the trigger circuit 610) may be configured to generate the trigger signal in response to the light pulse of the received light signal having the greatest signal level at the associated peak (e.g., in response to the light pulse having the greatest amplitude), illustratively in response to a main pulse of the received light signal.

The processing circuit 600 may be configured to determine the time of flight associated with the received light signal by using the generated trigger signal. Illustratively, the trigger signal may stop a timer (a TDC timer) associated with the received light signal. The timer may be started upon emission of the light signal and stopped upon reception of the light signal, and the running time of the timer may define the time-of-flight of the light signal. The timer may be a timer in a microprocessor, a field-programmable gate array (FPGA), or a dedicated TDC integrated circuit (IC), as examples.

FIG. 7A shows a threshold determination circuit 700 in a schematic view according to various aspects. The threshold determination circuit 700 may be an exemplary implementation of the threshold determination circuit 604 described in relation to FIG. 6.

The threshold determination circuit 700 may be configured to provide a threshold value for the identification of peaks in a received light signal (e.g., in the received light signal 404, e.g. in the received light signal provided at the input 602 of the processing circuit 600). The threshold determination circuit 700 may include a noise floor measurement circuit 702 and a trigger offset calculation circuit 704.

The noise floor measurement circuit 702 may be configured to determine (e.g., to estimate or to measure) an average signal level of the noise associated with a received light signal (e.g., an average noise power, an average noise current, an average noise voltage, or an average noise amplitude).

In some aspects, the noise floor measurement circuit 702 may be configured to determine the noise floor of the received light signal by analyzing the analog (electrical) signal representing the received light signal (e.g., the electrical signal coming from a transimpedance amplifier of a detector). The electrical signal may have an arbitrary waveform. The noise floor measurement circuit 702 may be configured to estimate the average signal level of the noise (e.g., the average noise power) by squaring and averaging the analog signal associated with the received light signal. The noise floor measurement circuit 702 may be configured to square and average the received light signal by using non-linear diode characteristics for squaring the signal in combination with an averaging capacitor. An exemplary implementation of the noise floor measurement circuit 702 is shown in FIG. 7B.

In other aspects, the noise floor measurement circuit 702 may be configured to estimate the average signal level of the noise by using one or more noise parameters associated with the received light signal. The one or more noise parameters may include at least one of a thermal noise and/or a shot noise associated with the received light signal. The noise floor measurement circuit 702 may be configured to estimate the average signal level of the noise by using a predefined model representing the noise based on the one or more noise parameters. Illustratively, additionally or alternatively to analyzing the detected analog signal (e.g., from the transimpedance amplifier), the noise floor may also be estimated using the measurement of secondary parameters. The noise present in the detected signal may strongly depend on temperature (thermal noise), ambient light (shot noise), and other factors. By measuring these parameters and using a suitable noise model the noise floor measurement circuit 702 may estimate the noise.

In some aspects, the trigger offset calculation circuit 704 may be configured to determine a threshold value (for peak identification) by using the estimated average signal level of the noise, as described above in relation to FIG. 1D. The trigger offset calculation circuit 704 may be configured to combine the noise floor with an offset value to determine the threshold value (illustratively, a trigger threshold value for peak detection). In some aspects, the trigger offset calculation circuit 704 may be configured to determine the threshold value by adding an offset value to the estimated average signal level of the noise (e.g., by adding an offset to the average noise power), e.g. in case a logarithmic representation is used. In other aspects, the trigger offset calculation circuit 704 may be configured to determine the threshold value by multiplying the estimated average signal level of the noise by an offset value (e.g., by a scaling factor), e.g. in case a linear representation is used. As numerical example, in linear scale, the offset value may be expressed by a factor in the range from 2 to 10, for example 4. As another numerical example, in logarithmic scale, the offset value may be chosen in the range between 3 dB and 10 dB, for example 6 dB.

FIG. 7B illustrates a circuit equivalent of a RMS-to-DC conversion circuit 710 for determining the noise floor of a received light signal in a schematic view according to various aspects. Other implementations of a RMS-to-DC conversion circuit may be known in the art for noise floor estimation on an electrical level. The circuit 710 may include an input 712 at which the input signal (e.g., in form of a voltage) may be provided. The input signal may be provided to a comparator 714, configured to compare the input signal with a signal provided at a second input 716 (provided at the amplifier 714 over a resistor 718, for example having a resistance of 8 kΩ). The amplifier 714 may be coupled with an absolute value circuit 720, and the absolute value circuit 720 may be configured to provide its output to a squarer divider 722. An output of the squarer divider 722 may be provided to an averaging capacitor 724. A node 726 coupled with the averaging capacitor 724 may be further coupled with a bias section 728. The bias section 728 may be provided with a bias voltage (at a first input 730) and with a power down signal (at a second input 732). The squarer divider 722 may be further coupled to a transistor 734, and the transistor 734 may be coupled to a network including a resistor 736 (e.g., having a resistance of 8 kΩ) and a capacitor 738.

FIG. 8A shows a peak identification circuit Boo in a schematic view according to various aspects. The peak identification circuit Boo may be an exemplary implementation of the peak identification circuit 606 described in relation to FIG. 6.

The peak identification circuit Boo may be configured to receive a received light signal (at a first input 802) and threshold information (at a second input 804). The threshold information may include a threshold value associated with the received light signal, e.g. as determined by a threshold determination circuit (e.g., the threshold determination circuit 604, 700 described above). Illustratively, the peak identification circuit Boo may be configured to identify the number of peaks in the received light signal by comparing the received light signal with the threshold value.

The peak identification circuit Boo may include a multi-peak trigger circuit 806 configured to generate a sequence of trigger signals in accordance with the received signal and the threshold value. Illustratively, the multi-peak trigger circuit 806 may be configured to detect peaks that are higher than the threshold value. As an exemplary implementation, the multi-peak trigger circuit 806 may include a comparator, for example in combination with a Schmitt trigger for adding a hysteresis. A generated trigger signal may illustratively correspond to a detected peak (a detected light pulse) in the received light signal.

In some aspects, the multi-peak trigger circuit 806 may be configured to implement at least one of the triggering schemes from the list of triggering schemes including or consisting of: a positive edge triggering scheme, a negative edge triggering scheme, a positive and negative edge triggering scheme, a threshold triggering scheme, a threshold with Schmitt Trigger triggering scheme, a pulse width triggering scheme, and/or a gradient triggering scheme.

The multi-peak trigger circuit 806 may be configured to generate a sequence of digitized values by comparing the received light signal with the threshold value. The multi-peak trigger circuit 806 may be configured to generate the sequence of digitized values by implementing one of the above-mentioned triggering schemes. The multi-peak trigger circuit 806 may be configured to generate the sequence of digitized values by assigning a first digitized value to the portions of the received light signal being above the threshold value (to the portions of the light signal being at a signal level greater than the threshold value) and by assigning a second digitized value to the portions of the received light signal being below the threshold value (to the portions of the light signal being at a signal level less than the threshold value). As an example, the first digitized value may be a logic “1” and the second digitized value may be a logic “0”, or vice versa.

In some aspects, the multi-peak trigger circuit 806 may be configured to provide a trigger signal for a time-of-flight measurement associated with the received light signal, e.g. upon reception of the received light signal (e.g., upon reception of the light pulse of the received light signal having the greatest signal level among the light pulses of the received light signal, e.g. upon reception of the first light pulse of a received light signal). The multi-peak trigger circuit 806 may be configured to provide the generated trigger signal to one or more processors configured to determine the time-of-flight.

In some aspects, the peak identification circuit Boo may include a register 808 (a trigger event register) configured to store the output of the multi-peak trigger circuit 806. The register 808 may be configured to store the sequence of trigger signals, e.g. the sequence of digitized values, generated by the multi-peak trigger circuit 806. The register 808 may be configured to store the sequence of trigger signals, e.g. the sequence of digitized values, by sampling the generated sequence at predefined time intervals. Illustratively, the register 808 may allow keeping a record of a history of subsequently arriving trigger pulses together with a measure that allows to deduct the relative time between trigger events. The register 808 may include a serial input and a parallel output. Exemplary implementations of the register 808 are illustrated in FIG. 8B and FIG. 8C. In an implementation, the register may record trigger events at equidistant time instants and may be implemented using a clocked register with a serial input and a parallel output (see FIG. 8B). In another implementation, the register 808 may include a tapped delay-line based realization (see FIG. 8C).

In some aspects, the peak identification circuit Boo may include a peak detection circuit 810 configured to identify the number of peaks in the received light signal based on the content of the register 808. The peak detection circuit 810 may be configured to identify the number of peaks in the received light signal by using the generated (and stored) sequence of trigger signals, e.g. the generated (and stored) sequence of digitized values. Based on the (digital) signature read out from the register 808, the peak detection circuit 810 may eventually determine how many peaks were detected. As an example, the peak detection circuit 810 may include one or more counters configured to count how many trigger events are recorded in the sequence stored in the register 808. As another example, the peak detection circuit 810 may be configured to identify the number of peaks in the received light signal by comparing the generated (and stored) sequence of trigger signals (the sequence of digitized values) with one or more known sequences (e.g., one or more known sequences of digitized values). Illustratively, the peak detection circuit 810 may store or may be configured to retrieve a mapping table that maps all possible signatures stored in the register to the number of identified peaks. This may be understood as a correlation-receiver approach. It is understood that other realizations may also be possible.

In some aspects, a histogram solution may be provided. The peak detection circuit 810 may be configured to identify the number of peaks in the received light signal based on the occurrences of the first digitized value in the sequence of digitized values (stored in the register 808). Illustratively, the register 808 and the peak detection circuit 810 may be adapted to provide a histogram of the incoming detection signals. This may be provided, for example, in case an array of ultra-sensitive photodetectors is used, which provide a trigger-like detection signal for photons as they arrive, e.g. in case single photon avalanche photo diodes (SPADs) are used. The histogram, with adequately chosen bins, may then be seen as integral part of the peak identification stage as peaks in the histogram may indicate peaks in the detected signal. In this implementation, the register 808 may be clocked at a higher rate.

FIG. 8B shows a register 820 in a schematic view according to various aspects. The register 820 may be an exemplary implementation of the register 808 described in relation to FIG. 8A.

The register 820 may be a shift register with flip-flops. Illustratively the register 820 may include one or more flip-flops (e.g., a first flip-flop 822-1, a second flip-flop 822-2, a third flip-flop 822-3, in this exemplary implementation), coupled with one another, and providing a parallel output at respective outputs 824-1, 824-2, 824-3 (Q₀, Q₁, . . . , Q_{N}). The flip-flops 822-1, 822-2, 822-3 may receive data at an input 826 of the register 820 and may be clocked by a common clock signal 828.

FIG. 8C shows a delay line 830 in a schematic view according to various aspects. The delay line 830 may be for use in a register (e.g., the register 808 may include, in some aspects, the delay line 830). The delay line 830 may include a plurality of capacitors, e.g. first to N-th capacitors 832-1, 832-2, 832-3, 832-4, 832-5, 832-6, 832-N in this exemplary configuration, and a plurality of inductors, e.g. first to N-th inductors 834-1, 834-2, 834-3, 834-4, 834-N, in this exemplary configuration. Illustratively, the delay line 830 may be configured as a lumped parameter delay line. The delay line 830 may provide that a signal provided at the delay line 830 is delayed (at the output of the delay line 830).

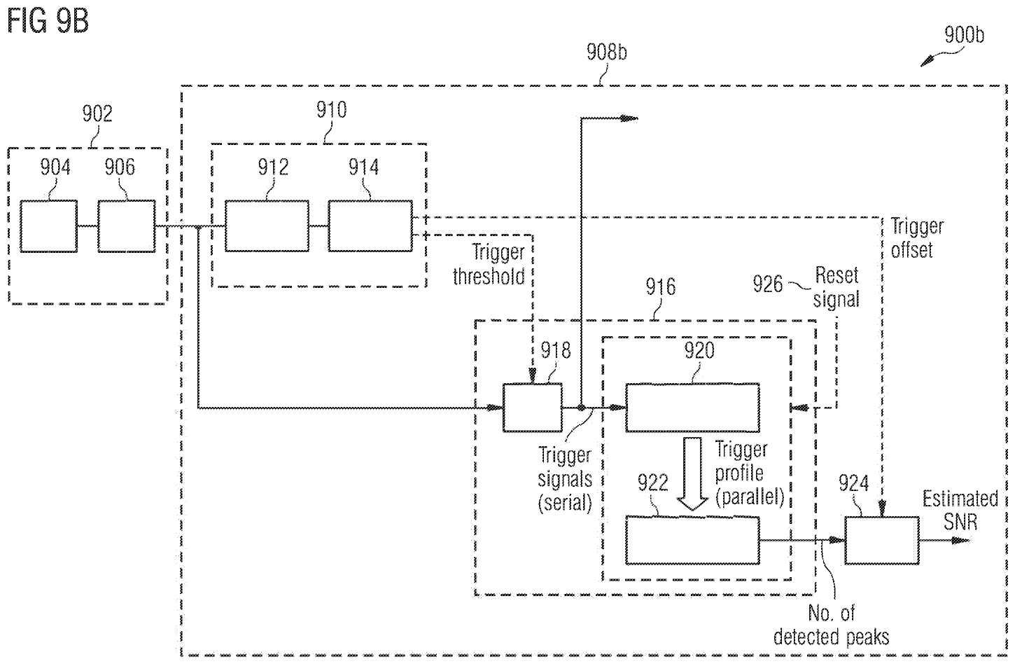

FIG. 9A and FIG. 9B show a respective light detection system 900a, 900b in a schematic view according to various aspects. These light detection systems 900a, 900b may be an exemplary realization of the light detection system 400 described in relation to FIG. 4.

The light detection systems 900a, 900b may include a detector 902 (e.g., an exemplary realization of the detector 402, 500 described above), e.g. including a photo diode 904 and a transimpedance amplifier 906, configured to provide a received light signal to a processing circuit 908a, 908b (e.g., an exemplary realization of the processing circuit 406, 600 described above).

The processing circuit 908a, 908b may include a threshold determination circuit 910 (e.g., an exemplary realization of the threshold determination circuit 604, 700 described above), e.g. including a noise floor measurement circuit 912 (e.g., configured as the noise floor measurement circuit 702 described above) and a trigger offset calculation circuit 914 (e.g., configured as the offset calculation circuit 704 described above).

The processing circuit 908a, 908b may include a peak identification circuit 916 (e.g., an exemplary realization of the peak identification circuit 606, Boo described above). The peak identification circuit 916 may include a multi-peak trigger circuit 918 (configured to receive the signal from the detector 902 and the trigger threshold value from the threshold determination circuit 910), the multi-peak trigger circuit 918 may be configured as the multi-peak trigger circuit 806 described above. The peak identification circuit 916 may include a trigger event register 920 configured to store the output of the multi-peak trigger circuit 918. The trigger event register 920 may be configured as the register 808 described above. The peak identification circuit 916 may include a peak detection circuit 922 configured to identify peaks in the received light signal based on the content of the trigger event register 920. The peak detection circuit 922 may be configured as the peak detection circuit 810 described above.

The peak identification circuit 916 may be configured to receive a reset signal 926, e.g. to reset the trigger event register 920 (to refresh the trigger event register 920).

The processing circuit 908a, 908b may include a SNR estimation circuit 924 configured to determine the signal-to-noise ratio associated with the received light signal (and amplitude information associated with the received light signal). The SNR estimation circuit 924 may be configured as the SNR estimation circuit 608 described above.

In the configuration of the light detection system 900a in FIG. 9A, the light detection system 900a may include a ToF trigger 928 (e.g., a Schmitt trigger) configured to provide a trigger signal in response to the received light signal, and configured to provide the trigger signal for time-of-flight measurement (e.g., to provide the trigger signal to one or more processors of the light detection system 900a, e.g. to a time-of-flight measuring circuit).

In the configuration of the light detection system 900b in FIG. 9B, the multi-peak trigger circuit 918 may be configured to provide the trigger signal for time-of-flight measurement (e.g., to provide the trigger signal to one or more processors of the light detection system 900b, e.g. to a time-of-flight measuring circuit).

A light detection system configured as described herein may provide that several components used in the ToF measurement and SNR estimation paths may be re-used, thus providing potential for a bill of materials (BOM) cost reduction. As an example, the multi-trigger circuit may be used both for the ToF measurement as well as the SNR estimation. Also, the noise floor measurement and trigger offset calculation circuit, introduced for the SNR estimation task, may be beneficial for the ToF measurement task as well.

FIG. 10 shows a LIDAR system moo in a schematic view according to various aspects. The LIDAR system moo may include a light emission system 1002 and a light detection system 1004. The light detection system 1004 may be configured as described herein, e.g. may be configured as the light detection system 400, 900a, 900b described in relation to FIG. 4, FIG. 9A, and FIG. 9B. The light emission system 1002 may be configured to emit light (in a field of view 1006 of the LIDAR system moo), and the light detection system 1004 may be configured to detect the light emitted by the light emission system 1002 (from the field of view 1006).

The light emission system 1002 may be configured to emit a light signal, e.g. an adapted light signal configured as described in relation to FIG. 2A to FIG. 2G. Illustratively the light emission system 1002 may be configured to emit a (first) light signal including a (first) plurality of peaks. The emitted light signal may include a (first) plurality of light pulses, each associated with a respective peak.

The light emission system 1002 may include a light source (not shown) configured to emit light having a predefined wavelength, for example in the infra-red and/or near infra-red range, such as in the range from about 700 nm to about 5000 nm, for example in the range from about 860 nm to about 1600 nm, or for example at 905 nm or 1550 nm. The light source may be configured to emit light in a pulsed manner, for example the light source may be configured to emit one or more light pulses (e.g., a sequence of light pulses). In some aspects, the light source may include a laser source. By way of example the light source may include one or more laser diodes, e.g. one or more edge-emitting laser diodes or one or more vertical cavity surface emitting laser diodes. The light source may be configured to emit one or more laser pulses, e.g. a sequence of laser pulses.

The detector of the light detection system 1004 may be configured to receive the (first) emitted light signal (e.g., a noisy version thereof) and to provide a received (first) light signal. The processing circuit of the light detection system 1004 may be configured to identify a number of peaks in the received (first) light signal, and to determine a signal-to-noise ratio associated with the received (first) light signal based on the number of identified peaks. In some aspects, the processing circuit of the light detection system 1004 may be configured to determine a signal-to-noise ratio associated with the received (first) light signal based on a comparison of the number of identified peaks with a number of peaks of the (first) plurality of peaks (of the emitted light signal).

The availability of SNR—and/or amplitude information the LIDAR system moo may provide more advanced adaptive ToF measurement schemes that would not be possible with a usual TDC-based architecture. The availability of SNR and/or amplitude information allows to flexibly react based on the current situation. It may be possible to adjust system settings over time and be adaptive, as described in further detail below. This may provide improving system performance and power efficiency or may make the system more versatile and robust in a variety of situations.

In some aspects, SNR-dependent power control may be provided. The light emission system 1002 may be further configured to emit a further (second) light signal, and to adapt a power of the second light signal in accordance with the signal-to-noise ratio associated with the first light signal. The light emission system 1002 may be configured to emit the second light signal with increased power with respect to the first light signal in case the signal-to-noise ratio associated with the first light signal is below a predefined threshold. The light emission system 1002 may be configured to adapt a difference between the respective peak powers associated with different peaks of the second plurality of peaks in accordance with the signal-to-noise ratio associated with the first light signal. Illustratively, the systems may start with a configuration in which not the full optical power is emitted (e.g., an overview shot may be provided). After identifying areas in the field of view which have a low SNR, the power may be increased for these areas in the field of view to obtain better measurements. An adaptive approach like this may provide achieving more flexible trade-offs of range/signal integrity versus power consumption/eye-safety. The same may apply based on amplitude information in addition or in alternative to the SNR information.

In some aspects, SNR-dependent coarse beam steering may be provided, e.g. the light emission system 1002 may include a coarse steering element (such as a liquid crystal polarization grating, LCPG) and may be configured to control the coarse steering element in accordance with the estimated SNR. Illustratively, the SNR-information may be used to adjust the coarse scanning pattern, e.g. as used in LCPG-based systems. The same may apply based on amplitude information in addition or in alternative to the SNR information.

In some aspects, a SNR dependent signal averaging may be provided. The light emission system 1002 may be further configured to emit a second light signal. The detector of the light detection system 1004 may be configured to receive the second light signal, and the processing circuit of the light detection system 1004 may be configured to adapt a number of averaging cycles to determine an average signal level of the noise associated with the received second light signal in accordance with the signal-to-noise ratio associated with the first light signal. Illustratively, the SNR-information may be used to adjust the number of signal averaging cycles at the detector that is used to improve the SNR. The same may apply based on amplitude information in addition or in alternative to the SNR information.

In some aspects, an adaptive measurement scheme may be provided, in which the light emission system 1002 is configured to adapt the emitted light signal(s) to adapt a resolution of the SNR measurement. Assuming that only a small number N of sub-pulses may be effectively used for SNR and/or amplitude estimation, it may be beneficial to provide an adaptive SNR and/or amplitude estimation, which is adaptively refined in subsequent steps.

As an example of the adaptive measurement scheme, the SNR measurement may start with a coarse staircase signal, e.g. using 7 sub-pulses, and a relatively large step-size of Δ₀=12 dB, covering a dynamic range of 72 dB. The multi-pulse may have the following configuration: [0 dB (main pulse), −12 dB, −24 dB, −36 dB, −48 dB, −60 dB, −72 dB]. After estimating the SNR with a coarse granularity of Δ₀=12 dB and determining the range of the coarse measurement, e.g. −36 dB<SNR_{coarse}<=−48 dB, a staircase could be constructed that includes one main pulse for ranging (same amplitude as before) and a concatenated staircase signal with 6 sub-pulses covering the range of the coarse measurement with finer resolution and a step-size of Δ₁=2 dB, e.g. −38 dB, −40 dB, −42 dB, −44 dB, −46 dB, −48 dB. The (second) multi-pulse may have the following configuration: [0 dB (main pulse), −38 dB, −40 dB, −42 dB, −44 dB, −46 dB, −48 dB]. Thus, combining the results of the initial and the refinement step, the virtual granularity of the SNR measurement would be of Δ₁=2 dB for the entire dynamic range of 72 dB leading to a virtual resolution of 36.

The described adaptive measurement scheme may be performed with more refinement steps, improving dynamic range and/or resolution. Stairs may be constructed in different ways. Also, the procedure may be performed taking amplitude measurements as a reference.

In some aspects, an emitted light signal may be used for data communication. Protocols may be formulated that use multi-pulse signals (e.g. staircase signals) together with feedback signals to identify suitable signaling parameters for data communication (e.g., to identify a suitable constellation size, equalization parameters, etc.).

In some aspects, more advanced pulse detection schemes may be provided. The more advanced pulse detection schemes may include: looking for a pulse; looking for a pulse and subsequently looking for the absence of a pulse; looking for a sequence of pulses; looking for a sequence of pulses and absent pulses; using relative trigger parameters for above schemes, e.g. a threshold that decreases for pulses that are closer to the noise floor (later pulses in the staircase). For relative triggers it may be beneficial, from an implementation complexity aspect, to use an “increasing staircase signal”. In some aspects, the signal may be filtered, e.g. low-pass filtered.

In the following, various aspects of this disclosure will be illustrated.

Example 1 is a light detection system including: a detector configured to provide a received light signal; and a processing circuit configured to: identify a number of peaks in the received light signal, and estimate a signal-to-noise-ratio associated with the received light signal based on the number of identified peaks.

In Example 2, the subject-matter of example 1 may optionally further include that the processing circuit is configured to provide a digitized representation of the received light signal.

In Example 3, the subject-matter of example 2 may optionally further include that the processing circuit is configured to convert the received light signal via time-to-digital conversion to provide the digitized representation of the received light signal.

In Example 4, the subject-matter of any one of examples 1 to 3 may optionally further include that the processing circuit is configured to estimate the signal-to-noise-ratio associated with the received light signal by using a preset difference between respective signal levels associated with different peaks in the received light signal.

In Example 5, the subject-matter of example 4 may optionally further include that the received light signal includes at least a first peak having a first peak power and a second peak having a second peak power different from the first peak power, and that the processing circuit is configured to estimate the signal-to-noise ratio associated with the received light signal by using a preset difference between the first peak power and the second peak power.

In Example 6, the subject-matter of any one of examples 1 to 5 may optionally further include that the processing circuit is configured to identify the number of peaks in the received light signal by comparing the received light signal with a threshold value.

In Example 7, the subject-matter of example 6 may optionally further include that the processing circuit is configured to generate a sequence of digitized values by comparing the received light signal with the threshold value.

In Example 8, the subject-matter of example 7 may optionally further include that the processing circuit is configured to generate the sequence of digitized values by assigning a first digitized value to the portions of the received light signal being above the threshold value and by assigning a second digitized value to the portions of the received light signal being below the threshold value.

In Example 9, the subject-matter of example 7 or 8 may optionally further include that the processing circuit is configured to generate the sequence of digitized values by implementing at least one of the triggering schemes from the list of triggering schemes including or consisting of: a positive edge triggering scheme, a negative edge triggering scheme, a positive and negative edge triggering scheme, a threshold triggering scheme, a threshold with Schmitt-Trigger triggering scheme, a pulse-width triggering scheme, and/or a gradient triggering scheme.

In Example 10, the subject-matter of any one of example 7 to 9 may optionally further include that the processing circuit is configured to store the generated sequence of digitized values.

In Example 11, the subject-matter of example 10 may optionally further include that the processing circuit is configured to store the sequence of digitized values by sampling the generated sequence of digitized values at predefined time intervals.

In Example 12, the subject-matter of any one of example 7 to 11 may optionally further include that the processing circuit is configured to identify the number of peaks in the received light signal by using the generated sequence of digitized values.

In Example 13, the subject-matter of any one of example 8 to 12 may optionally further include that the processing circuit is configured to identify the number of peaks in the received light signal based on the occurrences of the first digitized value in the sequence of digitized values.

In Example 14, the subject-matter of any one of example 8 to 13 may optionally further include that the processing circuit is configured to identify the number of peaks in the received light signal by comparing the generated sequence of digitized values with one or more known sequences of digitized values.

In Example 15, the subject-matter of any one of example 1 to 14 may optionally further include that the processing circuit is configured to estimate an average signal level of the noise associated with the received light signal.

In Example 16, the subject-matter of example 15 may optionally further include that the processing circuit is configured to estimate the average signal level of the noise by using one or more noise parameters associated with the received light signal.

In Example 17, the subject-matter of example 16 may optionally further include that the one or more noise parameters include at least one of a thermal noise and/or a shot noise associated with the received light signal.

In Example 18, the subject-matter of any one of examples 15 to 17 may optionally further include that the detector is configured to provide an analog signal associated with the received light signal, and that the processing circuit is configured to estimate the average signal level of the noise by squaring and averaging the analog signal associated with the received light signal.

In Example 19, the subject-matter of any one of examples 15 to 18 may optionally further include that the processing circuit is configured to determine the threshold value by using the estimated average signal level of the noise.

In Example 20, the subject-matter of example 19 may optionally further include that the processing circuit is configured to determine the threshold value by adding an offset value to the estimated average signal level of the noise.

In Example 21, the subject-matter of examples 4 and 6 may optionally further include that the processing circuit is configured to estimate the signal to noise ratio associated with the received light signal by subtracting one to the number of identified peaks, multiplying the result of the subtraction by the known difference between the respective powers associated with different peaks, and adding the result of the multiplication to the threshold value.

In Example 22, the subject-matter of any one of examples 1 to 21 may optionally further include that the processing circuit is further configured to estimate a signal level of at least one peak of the identified peaks in the received light signal.

In Example 23, the subject-matter of example 22 may optionally further include that the processing circuit is configured to estimate the signal level of the peak having the greatest signal level among the identified peaks in the received light signal.

In Example 24, the subject-matter of example 22 or 23 may optionally further include that the processing circuit is configured to estimate the signal level of the peak having the greatest signal level by using the estimated signal to noise ratio and the estimated average signal level of the noise associated with the received light signal.

In Example 25, the subject-matter of any one of examples 1 to 24 may optionally further include that the detector includes a photo diode configured to provide a first analog signal in response to the received light signal impinging onto the photo diode.

In Example 26, the subject-matter of example 25 may optionally further include that the detector further includes an amplifier circuit configured to provide a second analog signal by amplifying the first analog signal.

In Example 27, the subject-matter of example 26 may optionally further include that the amplifier circuit includes a transimpedance amplifier.

In Example 28, the subject-matter of any one of examples 25 to 27 may optionally further include that the photo diode includes at least one of a pin photo diode, an avalanche photo diode, a single photon avalanche diode, or a silicon photomultiplier.

In Example 29, the subject-matter of any one of examples 25 to 28 may optionally further include that the photo diode is configured to provide a respective signal for each photon impinging onto the photo diode.

In Example 30, the subject-matter of any one of examples 25 to 29 may optionally further include that the photo diode is configured to provide an aggregate analog signal representing the arrival of one or more photons at the photo diode over one or more time intervals.

In Example 31, the subject-matter of example 30 may optionally further include that the processing circuit is configured to generate an aggregate digitized signal by using the aggregate analog signal, and to identify the one or more peaks in the received light signal based on the aggregate digitized signal.

In Example 32, the subject-matter of example 31 may optionally further include that the aggregate digitized signal includes one or more first digitized signals associated with a presence of a photon and one or more second digitized signals associated with an absence of a photon, and that the processing circuit is configured to identify the number of peaks in the received light signal based on the occurrences of the first digitized signal in the aggregate digitized signal.

In Example 33, the subject-matter of any one of the examples 1 to 32 may optionally further include that the processing circuit is further configured to generate a trigger signal in response to the received light signal.

In Example 34, the subject-matter of example 33 may optionally further include that the processing circuit is further configured to determine a time-of-flight associated with the received light signal by using the generated trigger signal.

Example 35 is a LIDAR system including the light detection system according to any one of examples 1 to 34.

Example 36 is a system including: the light detection system according to any one of examples 1 to 34; and a light signal received at the light detection system.

In Example 37, the subject-matter of example 36 may optionally further include that the light signal includes a plurality of light pulses, and that each light pulse of the plurality of light pulses is associated with a respective peak. Illustratively, each light pulse of the plurality of light pulses may be associated with a respective signal level (at the associated peak).

In Example 38, the subject-matter of example 37 may optionally further include that the light pulses of the plurality of light pulses have one of a rectangular shape, a square shape, a Gaussian shape, or a sinusoidal shape.

In Example 39, the subject-matter of example 36 may optionally further include that the light signal includes an amplitude-modulated light signal including a plurality of peaks.

In Example 40, the subject-matter of any one of examples 36 to 39 may optionally further include that the light signal includes at least a first light pulse having a first amplitude and a first peak power, and a second light pulse having a second amplitude and a second peak power, and that the first amplitude is greater than the second amplitude and/or that the first peak power is greater than the second peak power.

In Example 41, the subject-matter of example 40 may optionally further include that the light signal includes a third peak having a third amplitude and a third peak power, and that the second amplitude is greater than the third amplitude and/or that the second peak power is greater than the third peak power.

In Example 42, the subject-matter of example 41 may optionally further include that a difference between the first amplitude and the second amplitude is equal to the difference between the second amplitude and the third amplitude, and/or that a difference between the first peak power and the second peak power is equal to a difference between the second peak power and the third peak power.

In Example 43, the subject-matter of example 42 may optionally further include that a difference between the first peak power and the second peak power is in the range from 3 dB to 20 dB in a logarithmic scale, for example in the range from 6 dB to 10 dB, for example equal to or less than 10 dB.

In Example 44, the subject-matter of example 43 may optionally further include that the second peak power is equal to or less than 90% of the first peak power in a linear scale.

In Example 45, the subject-matter of any one of examples 36 to 44 may optionally further include that the light signal includes a plurality of light pulses, and that a peak-to-peak distance between consecutive light pulses is in the range from about 50 ps to about 50 ns.

In Example 46, the subject-matter of example 45 may optionally further include that the light signal includes at least a first light pulse, a second light pulse, and a third light pulse, and that a first peak to peak distance between the first light pulse and the second light pulse is equal to a second peak to peak distance between the second light pulse and the third light pulse.

Example 47 is a LIDAR system including: a light emission system configured to emit a light signal including a plurality of peaks; and a light detection system including:
a detector configured to receive the light signal, and a processing circuit configured to identify a number of peaks in the received light signal, and to determine a signal-to-noise ratio associated with the received light signal based on the number of identified peaks.

In some aspects, the processing circuit may be configured to determine the signal-to-noise ratio associated with the received light signal based on a comparison of the number of identified peaks with a number of peaks of the first plurality of peaks.

In Example 48, the subject-matter of example 47 may optionally further include that the light emission system is further configured to emit a second light signal, and to adapt a power of the second light signal in accordance with the signal-to-noise ratio associated with the first light signal.

In Example 49, the subject-matter of example 48 may optionally further include that the light emission system is configured to emit the second light signal with increased power with respect to the first light signal in case the signal-to-noise ratio associated with the first light signal is below a predefined threshold.

In Example 50, the subject-matter of example 48 or 49 may optionally further include that the second light signal has a second plurality of peaks, and that the light emission system is configured to adapt a difference between the respective peak powers associated with different peaks of the second plurality of peaks in accordance with the signal-to-noise ratio associated with the first light signal.

In Example 51, the subject-matter of any one of examples 47 to 50 may optionally further include that the light emission system is further configured to emit a second light signal, that the detector of the light detection system is configured to receive the second light signal, and that the processing circuit of the light detection system is configured to adapt a number of averaging cycles to determine an average signal level of the noise associated with the received second light signal in accordance with the signal-to-noise ratio associated with the first light signal.

Example 52 is a method of estimating a signal to noise ratio associated with a light signal, the method including: providing a received light signal; identifying a number of peaks in the received light signal, and estimating a signal to noise ratio associated with the received light signal based on the number of identified peaks.

The method of example 52 may optionally further include one, or more than one, or each of the features recited in the examples 1 to 46, where appropriate.

While various implementations have been particularly shown and described with reference to specific aspects, it should be understood by those skilled in the art that various changes in form and detail may be made therein without departing from the spirit and scope as defined by the appended claims. The scope is thus indicated by the appended claims and all changes which come within the meaning and range of equivalency of the claims are therefore intended to be embraced.

1-15. (canceled)

16. A light detection system comprising:
a detector configured to provide a received light signal; and
a processing circuit configured to:
identify a number of peaks in the received light signal, and
estimate a signal-to-noise ratio associated with the received light signal based on the number of identified peaks.

17. The light detection system according to claim 16,
wherein the processing circuit is configured to estimate the signal-to-noise ratio associated with the received light signal by using a preset difference between respective signal levels associated with different peaks in the received light signal.

18. The light detection system according to claim 16,
wherein the received light signal comprises at least a first peak having a first peak power and a second peak having a second peak power different from the first peak power, and wherein the processing circuit is configured to estimate the signal-to-noise ratio associated with the received light signal by using a preset difference between the first peak power and the second peak power.

19. The light detection system according to claim 16,
wherein the processing circuit is configured to identify the number of peaks in the received light signal by comparing the received light signal with a threshold value.

20. The light detection system according to claim 16,
wherein the processing circuit is configured to estimate an average signal level of noise associated with the received light signal, and
wherein the processing circuit is configured to determine a threshold value for the received light signal by using the estimated average signal level of the noise.

21. The light detection system according to claim 16,
wherein the processing circuit is further configured to estimate a signal level of at least one peak of the identified peaks in the received light signal.

22. The light detection system according to claim 21,
wherein the processing circuit is configured to estimate the signal level of the peak having a greatest signal level by using an estimated signal-to-noise ratio and an estimated average signal level of noise associated with the received light signal.

23. The light detection system according to claim 16,
wherein the detector comprises a photo diode configured to provide an analog signal in response to the received light signal impinging onto the photo diode.

24. A system comprising:
the light detection system according to claim 16; and
a light signal received at the light detection system.

25. The system according to claim 24,
wherein the light signal comprises a plurality of light pulses, and wherein each light pulse of the plurality of light pulses is associated with a respective peak.

26. The system according to claim 24,
wherein the light signal comprises at least a first light pulse having a first amplitude and a first peak power, and a second light pulse having a second amplitude and a second peak power, and that the first amplitude is greater than the second amplitude and/or that the first peak power is greater than the second peak power.

27. The system according to claim 26,
wherein the light signal comprises a third peak having a third amplitude and a third peak power, and that the second amplitude is greater than the third amplitude and/or that the second peak power is greater than the third peak power.

28. The system according to claim 27,
wherein a difference between the first amplitude and the second amplitude is equal to the difference between the second amplitude and the third amplitude, and/or that a difference between the first peak power and the second peak power is equal to a difference between the second peak power and the third peak power.

29. A LIDAR system comprising:
a light emission system configured to emit a light signal comprising a plurality of peaks; and
a light detection system comprising:
a detector configured to receive the light signal, and
a processing circuit configured to identify a number of peaks in the received light signal, and to determine a signal-to-noise ratio associated with the received light signal based on the number of identified peaks.

30. A method of detecting light, the method comprising:
providing a received light signal;
identifying a number of peaks in the received light signal; and
estimating a signal to noise ratio associated with the received light signal based on the number of identified peaks.
